(19) United States
(12) Patent Application Publication
(10) Pub. No.: US 2024/0118739 A1
(43) Pub. Date: Apr. 11, 2024

(54) METHOD AND APPARATUS TO MANAGE PROCESSOR POWER CONSUMPTION BASED ON MESSAGE QUEUE UTILIZATION

(71) Applicant: Intel Corporation, Santa Clara, CA (US)

(72) Inventors: Abhinandan GUJJAR, Bangalore (IN); Ashok Kumar KALADI, Bangalore (IN)

(21) Appl. No.: 18/542,452

(22) Filed: Dec. 15, 2023

(51) Int. Cl. G06F 1/329; G06F 1/3296; G06F 11/34

(52) U.S. Cl. CPC G06F 1/329; G06F 1/3296; G06F 11/3409

(57) ABSTRACT

Methods, apparatus, and computer programs are disclosed for managing processor power consumption based on message queue utilization. In one embodiment, a method comprising: distributing messages to a set of processor cores of a processor, wherein one message is distributed per distribution round to one queue within a set of queues, each queue corresponding to one processor core within the set of processor cores and including one or more queue entries to be processed by the one processor core, and where the distribution is based on utilization of the set of queues; based on utilization of a corresponding queue for a processor core of the set of processor cores, determining a power state for the processor core to be changed to; and distributing a message to the corresponding queue, the message to cause the processor core to be set to the power state.

### TECHNICAL FIELD

Embodiments of the disclosure relate to the field of computing; and more specifically, the embodiments are related to managing processor power consumption based on message queue utilization.

### BACKGROUND ART

Reducing carbon emissions in computing and communication is a global initiative with many stakeholders. For workload on a computer processor, there are opportunities to leverage power management technologies to reduce power consumption based on immediate workload demand. This can be achieved both at heavy load condition and idle condition, delivering a path to reduced power consumption. This in turn makes the workload, processor, and data center energy efficient while supporting many of the ongoing green initiatives.

Power management features can enable system performance to be maintained while reducing overall energy consumption, and/or enabling greater system performance at existing power consumption levels. Many of the features can be managed on-the-fly, allowing fine grain reactions based on the system load.

### BRIEF DESCRIPTION OF THE DRAWINGS

The disclosure may best be understood by referring to the following description and accompanying drawings that are used to show embodiments of the disclosure.

FIG. 1 illustrates a system including a load balancer for power management per some embodiments.

FIG. 2 illustrates a flow diagram to assign a core to a suitable power state based on corresponding queue utilization per some embodiments.

FIG. 3 illustrates a flow diagram of a core to enter a suitable power state based on a received message per some embodiments.

FIG. 4 illustrates a flow diagram to manage processor power consumption per some embodiments.

FIG. 5 illustrates an example computing system.

FIG. 6 illustrates a block diagram of an example processor and/or System on a Chip (SoC) that may have one or more cores and an integrated memory controller.

FIG. 7 is a block diagram illustrating a computing system 700 configured to implement one or more aspects of the examples described herein.

FIG. 8A illustrates examples of a parallel processor.

FIG. 8B illustrates examples of a block diagram of a partition unit.

FIG. 8C illustrates examples of a block diagram of a processing cluster within a parallel processing unit.

FIG. 8D illustrates examples of a graphics multiprocessor in which the graphics multiprocessor couples with the pipeline manager of the processing cluster.

FIGS. 9A-9C illustrate additional graphics multiprocessors, according to examples.

FIG. 10 shows a parallel compute system 1000, according to some examples.

FIGS. 11A-11B illustrate a hybrid logical/physical view of a disaggregated parallel processor, according to examples described herein.

FIG. 12 is a block diagram of another example of a graphics processor.

FIG. 13 is a block diagram illustrating the use of a software instruction converter to convert binary instructions in a source ISA to binary instructions in a target ISA according to examples.

FIG. 14 is a block diagram illustrating an IP core development system 1400 that may be used to manufacture an integrated circuit to perform operations according to some examples.

### DETAILED DESCRIPTION

In the following description, numerous specific details are set forth. However, it is understood that embodiments of the disclosure may be practiced without these specific details. In other instances, well-known circuits, structures, and techniques have not been shown in detail in order not to obscure the understanding of this description.

Bracketed text and blocks with dashed borders (such as large dashes, small dashes, dot-dash, and dots) may be used to illustrate optional operations that add additional features to the embodiments of the disclosure. Such notation, however, should not be taken to mean that these are the only options or optional operations, and/or that blocks with solid borders are not optional in some embodiments of the disclosure.

References in the specification to “one embodiment,” “an embodiment,” “an example embodiment,” etc. indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “connected” means a direct electrical or magnetic connection between the things that are connected, without any intermediary devices, while the term “coupled” means either a direct electrical or magnetic connection between the things that are connected or an indirect connection through one or more passive or active intermediary devices. The term “circuit” means one or more passive and/or active components that are arranged to cooperate with one another to provide a desired function. A “set,” as used herein, refers to any positive whole number of items including one item.

Power Management Techniques and Load Balancing

A computer processor may implement one or more of existing power management techniques. In a multi-core processor, the voltage and/or frequency (clock speed) of a processor and/or each processor core (or core and the two terms are used interchangeably) within the processor may be changed. For example, a core may operate at a reduced voltage and/or frequency until more processing power is required. This is achieved by monitoring the core's workload (e.g., by application-level workload), and reducing the core's frequency when it is running idle or low workload while increasing it as the workload increases. A core may operate in a turbo mode, where the core runs at a voltage and/or frequency higher than the advertised or nominal ones in some scenarios. Note that while the discussion uses examples of changing voltage and/or frequency of a core of a processor, same/similar operations may be performed on other components of the processor or system on a chip (SOC) as well.

The increase or decrease of the voltage and/or frequency of a core may be based on power and/or thermal monitoring. For example, a performance monitoring module of the processor may monitor power consumption and temperature of the cores within the processor over a period to understand actual power usage patterns and actual thermal behavior of the cores. Once the power usage pattern is understood, appropriate power control policies will be established and enforced on the processor/the cores within the processor. Note that the power and/or thermal monitoring is not limited to the core area of a processor that contains the cores, and it may be done on regions of the processor external to the core area (sometimes referred to as the “uncore” region). The core area may include the cores, caches (e.g., L1 and L2), line-fill buffers and the region external to the core area may comprise components such as last level caches, a memory controller, accelerators, coprocessors, field-programmable gate arrays (FPGAs), and system agent. The result of the power and/or thermal monitoring may trigger the changes of voltages/frequencies on a core and a corresponding region.

A processor/core may enter different power states to control power consumption, where each power state corresponds to one or more specific voltages and/or frequencies. The power states include a set of performance states (commonly referred to as P-states) and idle states (commonly referred to as C-states). The number and definition of P-states and C-states vary depending on the specific processor model and architecture. Note that power states may also be referred to as power saving states/modes, energy-efficient states/modes, or other similar terms.

For example, a processor/core may be active and in one of the P-states, where each P state corresponds to a level of voltage and/or frequency. P0 state is known as the highest or maximum performance state. In this state, a processor/core operates at its highest voltage and/or frequency, providing maximum processing power. P0 state is used when the system is under heavy load and requires high performance. In some embodiments, a processor/core is referred to as operating in a turbo mode herein when the processor/core enters P0 state. P1, P2, etc. are intermediate performance states that represent decreasing levels of performance. In each subsequent P-state, the processor/core operates at a lower clock frequency and voltage, reducing power consumption while sacrificing some performance. These states are used to balance performance and power consumption based on the workload. Pn is the lowest performance state, with the lowest voltage and frequency of P-state operation.

The processor/core may also be idle and in one of the C-states. C0, as an operational state, represents any of the P-states, in which the processor/core is fully operational and executes instructions. C1 is the first idle state, where the processor/core is in a halt state, meaning it is not executing instructions but remains powered on and can quickly resume processing when needed. Some processors/cores use this state to reduce power when the system is lightly loaded. This may be referred to as a ready-standby state. C2, C3, . . . , Cn are deeper idle states, where the processor/core progressively reduces its power consumption by turning off parts of the SOC or core. Alternatively or additionally, parts of the SOC or core may be put into low-power modes. In deeper C-states, it takes longer for the processor/core to wake up and resume processing, but they offer more power savings.

One or more user space applications may be used to change the voltage and/or frequency on a processor/core to save power. For example, Data Plane Development Kit (DPDK) includes a set of libraries and tools that help developers build high-performance packet processing applications. DPDK includes features that can be used to improve the performance of packet processing applications, including poll mode drivers, which allow applications to directly poll network interfaces for incoming packets and transmit packets directly to network interfaces. DPDK applications can be designed to take advantage of multiple cores and logical processors. This can improve the performance of applications that need to process a large number of packets. DPDK power management features may be used to adjust the voltage and/or frequency of a processor/core to enter different P-states according to the utilization of a receiver (Rx) queue of the processor/core, or to enter different deeper C-States according to the adaptive algorithms to speculate brief periods of time suspending the application if no packets are received. The interfaces for adjusting the voltage and/or frequency of a processor/core are in the power management library; and C-State control is implemented in applications according to the different use cases.

In another example, OpenDataPlane's (ODP) power management features may be used to adjust the voltage and/or frequency of a processor/core to enter different P-states according to the utilization of a receiver (Rx) queue of the processor/core, or to enter different deeper C-States according to the adaptive algorithms to speculate brief periods of time suspending the application if no packets are received.

To implement existing power management techniques, additional processing cycles (also referred to as clock cycles, instruction cycles, computational cycles, execution cycles, or Central Processing Unit (CPU) cycles) are needed for monitoring the processor/core utilization for which power management is performed. For example, for power management based on the Rx queue of a processor/core, additional processing cycles are needed to continuously monitor the utilization of the Rx queue. When multiple Rx queues are used by the processor/core, the Rx queue monitoring may take a significant number of processing cycles specifically for performance monitoring to manage power consumption.

A load balancer is a hardware circuit to optimize the distribution of workload across cores in a multi-core processor. The load balancer balances the workload of applications running on the multi-core processor for achieving high performance and resource utilization, and the balancing is based on utilization of the cores so that no core is overburdened while other cores remain idle.

A load balancer may support a producer/consumer model and provide one or more virtualized producer to consumer queues. A producer in the producer/consumer model is an agent that has a type of message (e.g., task request, descriptor) to place onto a queue, and a consumer is an agent that removes the message from the queue. These messages describe the work for the consumer to execute (e.g., packet processing, storage operation, data movement, math operation, cryptographic operation) in some embodiments. The load balancer may support high queuing rates, load balancing across consumers, multi-priority queuing arbitration, multiple scheduling policies, coherency protocols, and efficient queue notification.

Data plane applications (e.g., DPDK, OpenDataPlane) may use poll mode drivers for packet processing. Poll mode drivers are designed to work without asynchronous notifications. Poll mode drivers query a queue for messages and then complete the associated task or assign it elsewhere to be completed and then immediately return to querying the queue. This means that the core(s) running the Poll Mode Driver may show 100% busy independent of how much work (other than queue queries) those cores are doing because of traffic caused by control messages. Since the core typically shows as 100% busy whether or not tasks are assigned to it, this may be referred to as busy-polling. Unless a core is monitored individually, it is hard to know whether a core is busy for work. Yet it is critical to accurately determine how busy a core is with non-polling activity to detect overload conditions and allow a user to adjust power consumption of cores based on the workload. A load balancer of a processor thus monitors workload on all coupled cores and has centralized information that can be leveraged to manage power consumptions on the cores, regions of the processor external to the core area, and/or the processor.

Architecture for Power Management

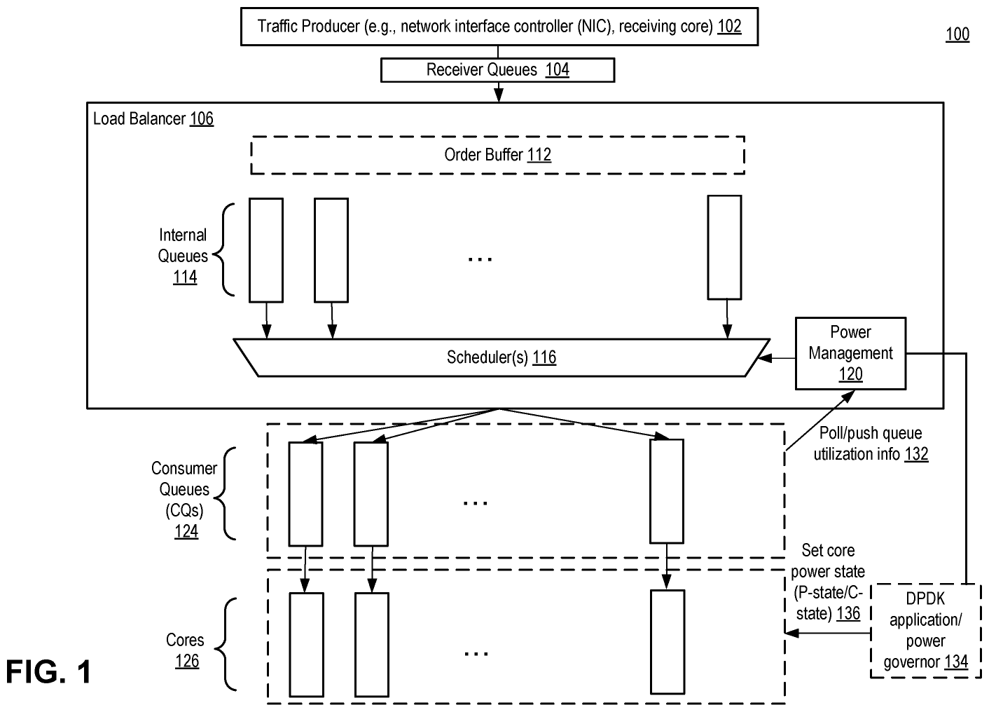

FIG. 1 illustrates a system including a load balancer for power management per some embodiments. Processor 100 includes a load balancer 106 to balance workload to a set of cores 126. Load balancer 106 supports a producer/consumer model where a traffic producer 102 provides workload (e.g., data packets/instructions) to one or more receiver (Rx) queues 104 for load balancer 106. Load balancer 106 then distributes the workload to consumer queues (CQs) 124, each corresponding to one core of cores 126.

Traffic producer 102 may be a network interface controller (NIC), a receiving core, or another entity to receive the workload and form messages to be queued in Rx queues 104. The messages are then provided to load balancer 106 (e.g., through a producer port (PP)), which stores the messages to one or more internal queues 114 of load balancer 106. In some embodiments, prior to being stored in internal queues 114, some or all of these queuing entities in receiver queues 104 are processed by one or more order buffers such as order buffer 112, which holds and manages the queuing entities in Rx queues 104 so that dependency of the queuing entities may be tracked, and the queuing entities may be executed by load balancer 106, e.g., speculatively and/or out of order.

The messages in internal queues 114 are distributed through one or more schedulers 116 to the consumer queues 124 to be executed. Schedulers 116 distribute messages based on a variety of factors, depending on the features supported by load balancer 106.

For example, load balancer 106 may support load balancing across consumers, each of which corresponds to a core of cores 126. Cores 126 may be homogenous or heterogeneous in terms of architecture, purpose, capability, energy efficiency, and/or other measures. When cores 126 are homogenous, the messages may be distributed evenly, but when they are heterogeneous, the messages will typically be distributed asymmetrically to ensure all cores are utilized efficiently so that no core is overburdened while other cores remain idle or so that tasks are assigned to the cores best suited to the operations associated with the given task. The load balancing across the cores is based on existing workload on each of cores 126.

Load balancer 106 may support multi-priority queuing arbitration and/or multiple scheduling policies. The messages may be assigned to different priorities (higher priority messages may be distributed ahead of lower priority ones and/or to higher performance core), and/or schedulers 116 follow one or more specific scheduling policies such as fair share, round-robin, or affinity basis (messages being distributed to or excluded from specific cores for workload isolation, performance optimization, or other reasons). The queuing arbitration and policy enforcement may be considered along with the existing workload on cores 126 for schedulers 116 to determine how to distribute messages from the internal queues 114 to consumer queues 124. In some embodiments, for each distribution round, one message from the internal queues 114 is distributed to one of consumer queues 124. In some examples, the priority or queue selection may consider Service Level Agreement (SLA) or Service Level Objectives associated with the workloads.

To determine the existing workload on each of cores 126, the utilization of each corresponding queue of consumer queues 124 is monitored. For example, the utilization of a core may be indicated by queue utilization such as the depth of the queue (how full is the queue). The queue utilization information is provided to schedulers 116 to schedule the distribution. While schedulers 116 already collects the information to schedule its distribution, embodiments leverage the queue utilization information to determine which power states each of cores 126 should be set based on the respective workload as well. As shown at reference 132, the information is provided to a power management module 120 through either polling from load balancer 106 or push by the consumer queues 124 (periodically or being triggered by event(s)). In some embodiments, power management module 120 is a circuit dedicated to power management of the processor/cores or shared with another management function. In alternative embodiments, power management module 120 may be implemented as a software module in load balancer 106 to manage power of the processor/cores (with additional processing cycles).

Power management module 120 monitors the depth of the consumer queues 124 to understand the workload on each core. This logic is expected to run for a brief amount of time (e.g., one decided by a preconfigured time period) and monitors each queue of the consumer queues 124. Based on the information, power management module 120 may decide to put a core to a specific power state, either a P-state or C-state. Based on the decided power state, power management module 120 may form a message indicating the decided power state for the core and the message is given to schedulers 116, which distributes the message to the core. The core may be put into the decided power state at reference 136, e.g., through a polling application with a power management feature and/or a power governor as shown at reference 134. The power governor is a component of the operating system or firmware that controls and manages the power consumption of a processor/core, and it may implement Dynamic Voltage and Frequency Scaling (DVFS) to adjust voltage and frequency of the processor core.

In some embodiments, power management module 120 also monitors the thermal conditions of cores 126, and the temperatures of cores 126 may be considered along with queue utilization of the consumer queues 124 to decide the power state for a core. For example, when the consumer queue of a core is full, but the core is measured to be hot, power management module 120 may decide to put the core into P1 state instead of P0, the latter of which would be the choice if the core is in a normal temperature. The thermal condition of cores 126 may be obtained by power management module 120 in a variety of ways. For example, polling or pushing the information for load balancer 106 (similar to the operations at reference 132), or messages may be generated to include the information and transmitted from cores 126 to load balancer 106. Note that load balancer 106 may monitor the thermal conditions of cores 126 already, thus power management module 120 leverages the existing load balancer 106 functionality.

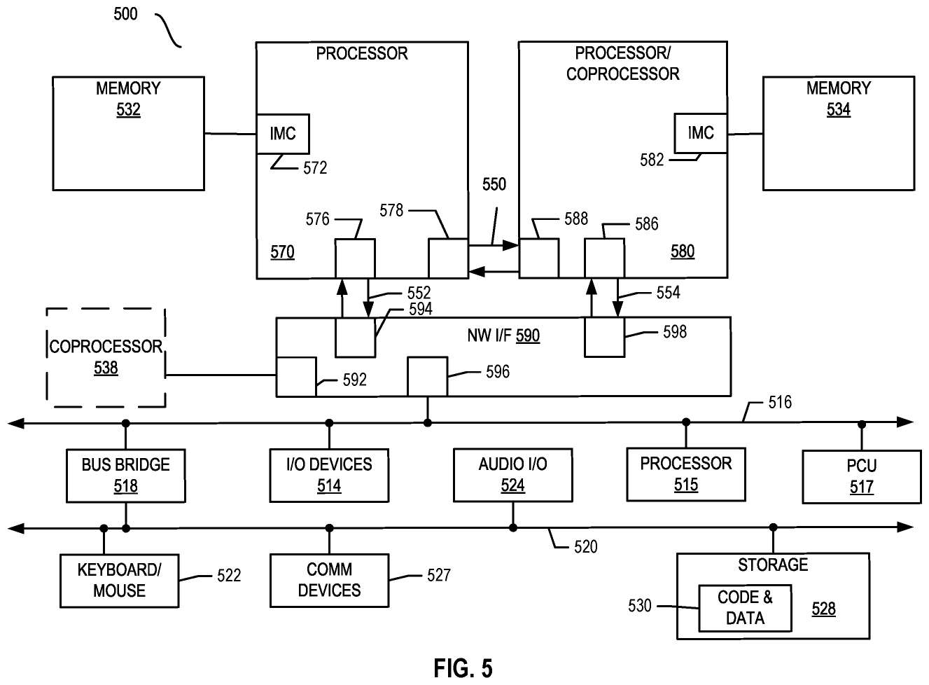

Note that processor 100 may be any type of processors for which a load balancer is implemented, and embodiments discussed herein may be operated on these processors, including processors/SoCs discussed herein below relating to FIGS. 5 to 14.

In some embodiments, a power management system for a processor (e.g., processor 100) comprises a load balancer (e.g., DLB 106) configured to distribute workloads across multiple cores by managing queues; a queue utilization monitor circuitry and logic (e.g., power management module 120) integrated with the load balancer, the queue utilization monitor circuitry and logic configured to monitor queue utilization and direct traffic to the cores, and a power control unit (e.g., within power management module 120) integrated with the load balancer, the power control unit configured to dynamically adjust energy consumption levels of the cores based on the monitored queue utilization. The cores are configured to resume standard activity upon receiving a corresponding wake-up signal (e.g., (e.g., a timer expiring to an interrupt being received)) in some embodiments.

In some embodiments, the queue utilization monitor circuitry and logic is further configured to assess the depth of consumer queues (CQs) associated with the cores, correlate the CQ depth to a corresponding energy consumption setting, and generate power management signals based on the CQ depth to modify the energy consumption levels of the cores. The energy consumption settings include a range of performance levels for the cores (e.g., P-state and/or C-state).

In some embodiments, the power control unit is further configured to activate a high-performance mode when the CQ depth indicates a high utilization, maintain a standard performance mode when the CQ depth indicates partial utilization, and reduce to a low-power mode when the CQ depth indicates no utilization.

In some embodiments, the load balancer is further configured to support one or more of a producer/consumer model, high queuing rates, load balancing across consumers, prioritized queuing, multiple scheduling types, and queue notification.

In some embodiments, the load balancer is further configured to operate in a poll mode, wherein the cores poll the consumer queues (CQs) and the power control unit adjusts the energy consumption levels of the cores based on the frequency of empty versus non-empty poll results, thereby modifying power consumption associated with varying network traffic.

In some embodiments, the power control unit is further configured to interface with a power management library or a system governor to control the energy consumption levels of the cores.

In some embodiments, a system for managing energy consumption in a processor (e.g., processor 100) comprises a load balancer (e.g., DLB 106) configured to monitor and distribute workloads across multiple cores; circuitry and logic configured to assess the utilization of consumer queues (CQs) associated with the cores and to determine appropriate energy consumption settings based on the utilization; a power control unit configured to receive determinations from the circuitry and logic and to adjust the energy consumption levels of the cores accordingly.

In some embodiments, the load balancer may further comprises computer-readable storage medium containing instructions executable by the processor to implement operations including monitoring the utilization of consumer queues (CQs) associated with multiple cores; determining, determining, by circuitry and logic, appropriate energy consumption settings for the cores based on the monitored utilization; and adjusting, by a power control unit, the energy consumption levels of the cores in accordance with the determined settings.

In some embodiments, determining the appropriate energy consumption settings includes correlating the consumer queue utilization to a predefined set of energy consumption levels.

In some embodiments, adjusting the energy consumption levels includes activating a high-performance mode for full or near full queue utilization, maintaining a standard performance mode for partial queue utilization, and reducing to a low-performance mode for no queue utilization. In some embodiments, the operations further include placing one or more cores into a reduced activity state upon receiving a specific signal and resuming standard activity upon receiving a corresponding wake-up signal.

In some embodiments, the operations further include providing an interface for user applications to configure predefined energy consumption settings based on specific workload requirements.

In some embodiments, the operations further include operating the load balancer in a poll mode, where the cores poll the consumer queues and the power control unit adjusts the energy consumption levels of the cores based on the frequency of empty versus non-empty polls, thereby adjusting energy consumption during periods of varying network traffic.

In some embodiments, the load balancer is further configured to support a producer/consumer model, enabling a producer to enqueue messages and a consumer to dequeue messages for processing.

In some embodiments, the power control unit of the load balancer is further configured to interface with a power management library or a system governor to facilitate the control of the energy consumption levels of the cores.

By utilizing information obtained for load balancer 106 to distribute messages to cores 126, power management module 120 may manage power consumptions by cores, regions of the processor external to the core area, and/or the processor, all of which can be done without adding additional processing cycles. By leveraging existing architecture/features of a load balancer, these embodiments provide more efficient power management than prior approaches at the granularity of cores.

Operations of Entering Different Power States

As discussed, the utilization of a consumer queue for a core may cause the core to enter a corresponding power state. In some embodiments, a set of predefined/learned mappings between utilization levels and power states are stored in a processor, where each utilization level maps to a power state (e.g., a P-state). The mappings may be stored in a data structure such as a map, a dictionary, a list, an array, a file, or a table. Based on the mapping, power management module 120 may determine the suitable power state of a core quickly.

In some embodiments, the mappings are formed through user preference. Alternatively/additionally, the mappings are formed based on heuristics and/or machine learning. For example, to determine the optimal mappings between utilization levels and power states, one or more machine learning models may be used, including supervised learning, unsupervised learning, semi-supervised learning, or other types of learning. The machine learning models can use artificial neural networks, decision trees, support-vector machines, regression analysis, Bayesian networks, genetic algorithms, or any other framework. The machine learning models may be trained with one or more goals including minimizing processor power consumption and/or maximizing processor performance at specific power consumption level.

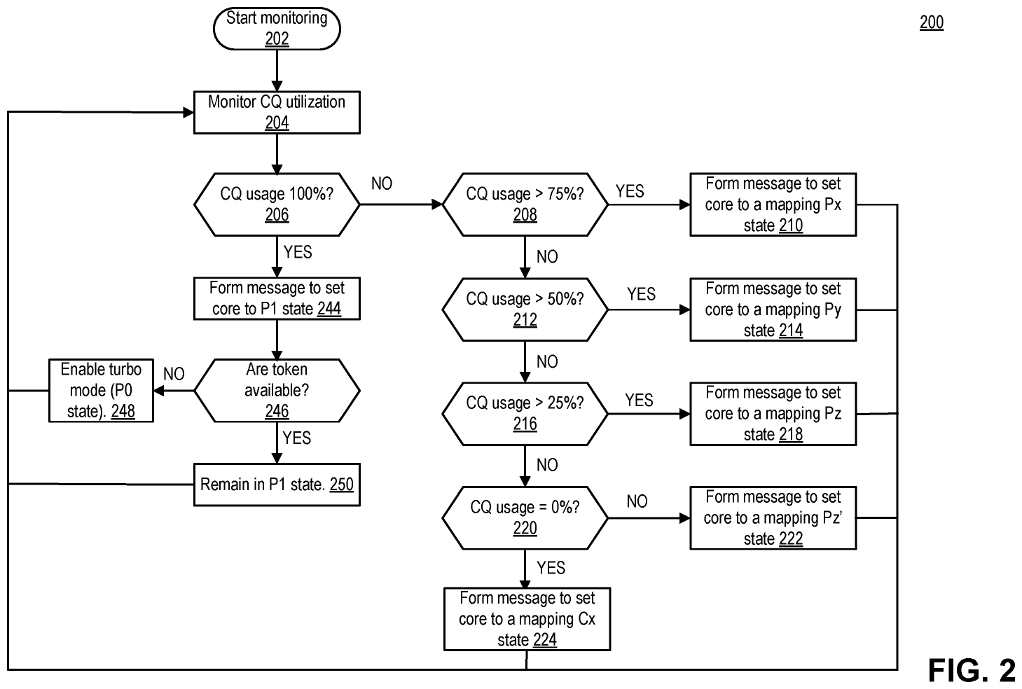

FIG. 2 illustrates a flow diagram to assign a core to a suitable power state based on corresponding queue utilization per some embodiments. Method 200 shown in the flow may be implemented by a load balancer (e.g., load balancer 106) of a processor (e.g., processor 100).

At reference 202, the monitoring is started. The monitoring is performed on all active cores coupled to the load balancer. If a core is in an idle state Cx (e.g., one of C1 to Cn), it may be brought to active state (C0) state through the load balancer distributing a message. The message may be distributed to the idle core, indicating a monitor event (e.g., UMONITOR), which requests the core to wake up from sleep when a specific event (e.g., a timer expiring to an interrupt being received) occurs. In some embodiments, the indication is an instruction with two arguments: the event to monitor and the address of a function to call when the event occurs. Upon the occurrence of the specific event, the core is brought to C0 state. The message may also be distributed to an active core, indicating a wake-up event call by the active core to wake up the idle core.

For each core that is monitored, the current queue utilization information of the corresponding consumer queue is received at reference 204. The current queue utilization information may be obtained after monitoring the consumer queue for a time period (predefined or selected in run-time). The selection of the time period may be based on user preference, heuristics, and/or machine learning, similar to the mapping determination between utilization levels and power states.

If the queue utilization is determined to be at 100% (or close to 100%) at reference 206, P1 is selected to be the proper power state for the core to be set to, and a message is formed to set the core to P1 state at reference 244.

Then it is determined whether the core can be set to turbo mode at reference 246. In some embodiments, when a core dequeues a message from its corresponding consumer queue, it releases a token back to the load balancer indicating that the message has been consuming by the core so that the load balancer is free to schedule the next messages in the internal queues. The load balancer may provide one or more tokens for a core to enter turbo mode during/after a distribution round, and the first core(s) to obtain the token(s) may enter turbo mode. At reference 246, it is determined whether a token is available to the core to enter turbo mode. If so, the flow goes to enabling turbo mode (P0 state in the embodiment) at reference 248; otherwise, the flow goes to keeping the core remain in P1 state at reference 250. After the operations at either reference 248 or 250, the flow goes back to monitoring phase at reference 204. If the selected P0/P1 state is not the current state of the core, a message is formed to set the core to the selected P0/P1 state and the message is distributed to the core in a distribution round allocated to the core.

If the queue utilization is less than 100% but more than 75% as determined at reference 208, a mapping Px (e.g., P2) is selected to be the proper power state for the core to be set to at reference 210. Yet if the queue utilization is less than 75% but more than 50% as determined at reference 212, a mapping Py (e.g., P3) is selected to be the proper power state for the core to be set to at reference 214. If the queue utilization is less than 50% but more than 25% as determined at reference 216, a mapping Pz (e.g., P) is selected to be the proper power state for the core to be set to at reference 218. Furthermore, if the queue utilization is less than 25% but more than 0% (no pending workload) as determined at reference 220, a mapping Pz′ (e.g., P4) is selected to be the proper power state for the core to be set to at reference 222. Otherwise, the queue utilization is at 0%, and a mapping idle state Cx (e.g., one of C1 to Cn) is selected to be the proper power state for the core to be set to at reference 224. Each of the selection of the mapping power state (P-state or C-state) is based on the set of mappings between utilization levels and power states. While not shown, the load balancer may determine that the current power state core is the optimal power state based on the set of mappings. When that happens, no message is formed to cause a power state change of the core.

While the utilization levels of a consumer queue are represented as percentages in FIG. 2, other representation may be used in alternative embodiments, e.g., the queue depth indicted by (1) the number of messages in a consumer queue or (2) the number of bytes/bits occupied by messages in the consumer queue. The data structure for the mappings utilization levels and power states may be based on one or more representations of the utilization levels of the consumer queue.

Note that method 200 is shown as a series of operations in the queue utilization determination and the corresponding message forming. These operations may be performed in one cycle without multiple threshold comparisons. For example, the load balancer may learn the queue utilization is 60%, based on the mapping data structure, it determines that the proper power level for the core is Py state.

The messages formed to cause a core to enter a particular mapping power state may include a power management instruction to cause the core to do so. For example, the message may include an instruction such as User-Mode Monitor Wait (UMWAIT) or Monitor Wait (MWAIT) to cause a core to enter the Cx state. The former instruction is used by user-level applications while the latter is used by both user-level and the operating system. The core may then be brought back to an active state through a message including an instruction such as UMONITOR discussed herein above.

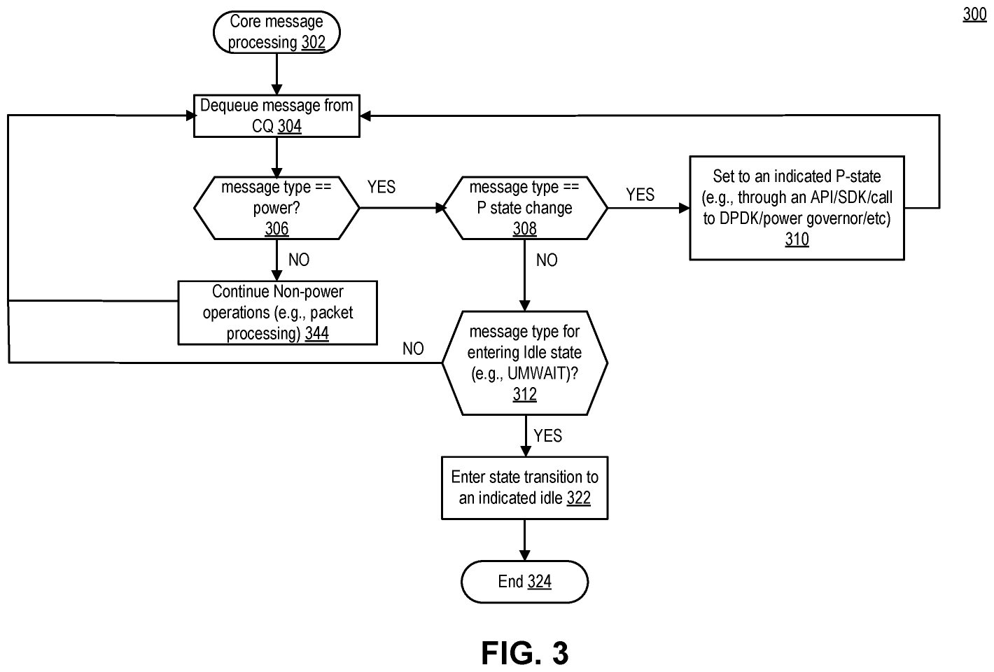

FIG. 3 illustrates a flow diagram of a core to enter a suitable power state based on a received message per some embodiments. Method 300 shown in the flow may be implemented by a core (e.g., any of cores 126) of a processor (e.g., processor 100).

At reference 302, a core processes one or more messages in its corresponding consumer queue. The core may be woken up from a Cx idle state. The core then dequeues messages from the consumer queue at reference 304. The flow then goes to reference 306 to determine the message type. Each message in a consumer queue is categorized in a message type within a group of message types to be processed by the processor. For example, the message types may include (1) data packet corresponding to data to be processed, (2) instructions for data processing (e.g., integer/floating point/vector), and (3) instructions for control (e.g., branch prediction/speculative execution, power management, interrupts/exceptions). The message types may include be categorized hierarchically and a message may belong to a subclass of a class. The message type indication of a message may be tagged to the message or may be stored somewhere else for examination.

If it is determined that the message is not for power management at reference 306, the flow goes to reference 344, where the core continues non-power operations (e.g., processing packets corresponding to the message). Once the message is processed, the flow goes back to reference 304 for the next message in the corresponding consumer queue.

If it is determined that the message is for power management at reference 306, the flow goes to reference 308 to determine whether the message type indicates the message is for a P-state change. If it is, the flow goes to reference 310, where the core is set to an indicated P-state. The setting may be through a software development kit (SDK), an Application Programming Interface (API), a Command Line Interface (CLI), or a function call. The entering of the P-state may be through a DPDK application, or a power governor as discussed herein.

If the message type indicates the message is not for a P-state change, the flow goes to reference 312 to determine whether the message indicates a message type for entering an idle state. For example, the message may include an instruction such as UMWAIT or MWAIT to cause a core to enter a particular Cx state. If not, the message is determined not to include state transition information and the flow goes back to reference 304.

If the message does indicate a message type for entering an idle state, the flow goes to reference 322, and the core enters a state transition to an idle state as indicated in the message. The state transition may be through a SDK, an API, a CLI, or function call, similarly or different from the ones causing the core to an indicated P-state. Once the core enters the indicated idle state, it becomes idle and no longer processes messages and the flow ends at reference 324.

### Operations in Some Embodiments

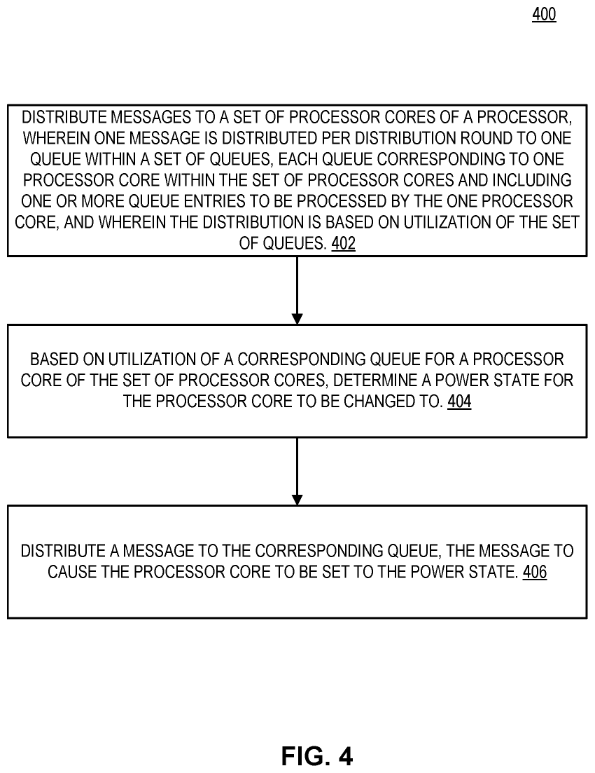

FIG. 4 illustrates a flow diagram to manage processor power consumption per some embodiments. The operations in method 400 are performed by a load balancer (e.g., load balancer 106) of a processor (e.g., processor 100) discussed herein.

At reference 402, distributing messages are distributed to a set of processor cores of a processor, wherein one message is distributed per distribution round to one queue within a set of queues, each queue corresponding to one processor core within the set of processor cores and including one or more queue entries to be processed by the one processor core, and wherein the distribution is based on utilization of the set of queues.

At reference 404, based on utilization of a corresponding queue for a processor core of the set of processor cores, a power state is determined for the processor core to be changed to.

At reference 406, a message is distributed to the corresponding queue, the message to cause the processor core to be set to the power state.

In some embodiments, the power state for the processor core is an updated performance state for the processor core, and the updated performance state is determined based on a mapping of the updated performance state and the utilization of the corresponding queue.

In some embodiments, wherein a data structure stores mappings between a plurality of performance states and a corresponding plurality of utilization levels, and determining the updated performance state for the processor core is based on looking up of the data structure.

In some embodiments, the processor core was brought to an active state from an idle state through a monitor instruction to the processor core before messages were distributed to the processor core. In some embodiments, the processor core was brought to the active state through a message indicating the monitor instruction, wherein the monitor instruction is triggered by a call from another core of the processor. For example, the monitor instruction may be UMONITOR discussed herein above.

In some embodiments, the utilization of the corresponding queue is measured by a plurality of utilization levels, and wherein responsive to a utilization level is no higher a first threshold, the processor core is to be set to an idle state. For example, the first threshold may be zero queue utilization as discussed herein above.

In some embodiments, the utilization of the corresponding queue is measured by a plurality of utilization levels, wherein responsive to the utilization level crosses a second threshold, the processor core is to be set to a turbo mode, in which the processor core is to run at a frequency higher than an advertised frequency of the processor core. For example, the second threshold may be 100% queue utilization as discussed herein above.

In some embodiments, the power state for the processor core is an idle state and the message indicates a wait instruction, based on which the processor core enters the idle state until an event occurs. The wait instruction may be one of MWAIT or UMWAIT discussed herein above.

In some embodiments, the idle state is selected from a plurality of idle states based on the wait instruction. For example, the plurality of idle state may include C1 to Cn.

In some embodiments, the processor core is set to the power state using a Data Plane Development Kit (DPDK) application coupled to the processor core.

Figures herein below describe a number of systems and processors in which embodiments in this disclosure may be implemented as examples, and the embodiments are not limited to these exemplary systems and processors.

### Example Systems

FIG. 5 illustrates an example computing system. Multiprocessor system 500 is an interfaced system and includes a plurality of processors or cores including a first processor 570 and a second processor 580 coupled via an interface 550 such as a point-to-point (P-P) interconnect, a fabric, and/or bus. In some examples, the first processor 570 and the second processor 580 are homogeneous. In some examples, first processor 570 and the second processor 580 are heterogenous. Though the example system 500 is shown to have two processors, the system may have three or more processors, or may be a single processor system. In some examples, the computing system is a system on a chip (SoC), Infrastructure Processing Unit (IPU), Edge Processing Unit (EPU), Data Processing Unit (DPU), or any other types of Processing Unit (xPU).

Processors 570 and 580 are shown including integrated memory controller (IMC) circuitry 572 and 582, respectively. Processor 570 also includes interface circuits 576 and 578; similarly, second processor 580 includes interface circuits 586 and 588. Processors 570, 580 may exchange information via the interface 550 using interface circuits 578, 588. IMCs 572 and 582 couple the processors 570, 580 to respective memories, namely a memory 532 and a memory 534, which may be portions of main memory locally attached to the respective processors.

Processors 570, 580 may each exchange information with a network interface (NW I/F) 590 via individual interfaces 552, 554 using interface circuits 576, 594, 586, 598. The network interface 590 (e.g., one or more of an interconnect, bus, and/or fabric, and in some examples is a chipset) may optionally exchange information with a coprocessor 538 via an interface circuit 592. In some examples, the coprocessor 538 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 570, 580 or outside of both processors, yet connected with the processors via an interface such as P-P interconnect, such that either or both processors' local cache information may be stored in the shared cache if a processor is placed into a low power mode.

Network interface 590 may be coupled to a first interface 516 via interface circuit 596. In some examples, first interface 516 may be an interface such as a Peripheral Component Interconnect (PCI) interconnect, a PCI Express interconnect or another I/O interconnect. In some examples, first interface 516 is coupled to a power control unit (PCU) 517, which may include circuitry, software, and/or firmware to perform power management operations with regard to the processors 570, 580 and/or coprocessor 538. PCU 517 provides control information to a voltage regulator (not shown) to cause the voltage regulator to generate the appropriate regulated voltage. PCU 517 also provides control information to control the operating voltage generated. In various examples, PCU 517 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 517 is illustrated as being present as logic separate from the processor 570 and/or processor 580. In other cases, PCU 517 may execute on a given one or more of cores (not shown) of processor 570 or 580. In some cases, PCU 517 may be implemented as a microcontroller (dedicated or general-purpose) or other control logic configured to execute its own dedicated power management code, sometimes referred to as P-code. In yet other examples, power management operations to be performed by PCU 517 may be implemented externally to a processor, such as by way of a separate power management integrated circuit (PMIC) or another component external to the processor. In yet other examples, power management operations to be performed by PCU 517 may be implemented within BIOS or other system software.

Various I/O devices 514 may be coupled to first interface 516, along with a bus bridge 518 which couples first interface 516 to a second interface 520. In some examples, one or more additional processor(s) 515, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 516. In some examples, second interface 520 may be a low pin count (LPC) interface. Various devices may be coupled to second interface 520 including, for example, a keyboard and/or mouse 522, communication devices 527 and storage circuitry 528. Storage circuitry 528 may be one or more non-transitory machine-readable storage media as described below, such as a disk drive or other mass storage device which may include instructions/code and data 530 and may implement a storage in some examples. Further, an audio I/O 524 may be coupled to second interface 520. Note that other architectures than the point-to-point architecture described above are possible. For example, instead of the point-to-point architecture, a system such as multiprocessor system 500 may implement a multi-drop interface or other such architecture.

### Example Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

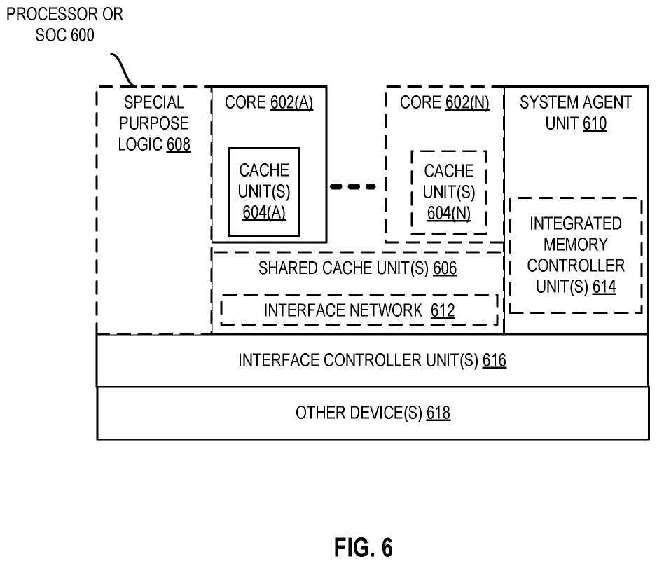

FIG. 6 illustrates a block diagram of an example processor and/or SoC 600 that may have one or more cores and an integrated memory controller. The solid lined boxes illustrate a processor 600 with a single core 602(A), system agent unit circuitry 610, and a set of one or more interface controller unit(s) circuitry 616, while the optional addition of the dashed lined boxes illustrates an alternative processor 600 with multiple cores 602(A)-(N), a set of one or more integrated memory controller unit(s) circuitry 614 in the system agent unit circuitry 610, and special purpose logic 608, as well as a set of one or more interface controller units circuitry 616. Note that the processor 600 may be one of the processors 570 or 580, or coprocessor 538 or 515 of FIG. 5.

Thus, different implementations of the processor 600 may include: 1) a CPU with the special purpose logic 608 being integrated graphics and/or scientific (throughput) logic (which may include one or more cores, not shown), and the cores 602(A)-(N) being one or more general purpose cores (e.g., general purpose in-order cores, general purpose out-of-order cores, or a combination of the two); 2) a coprocessor with the cores 602(A)-(N) being a large number of special purpose cores intended primarily for graphics and/or scientific (throughput); and 3) a coprocessor with the cores 602(A)-(N) being a large number of general purpose in-order cores. Thus, the processor 600 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 600 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 604(A)-(N) within the cores 602(A)-(N), a set of one or more shared cache unit(s) circuitry 606, and external memory (not shown) coupled to the set of integrated memory controller unit(s) circuitry 614. The set of one or more shared cache unit(s) circuitry 606 may include one or more mid-level caches, such as level 2 (L2), level 3 (L3), level 4 (L4), or other levels of cache, such as a last level cache (LLC), and/or combinations thereof. While in some examples interface network circuitry 612 (e.g., a ring interconnect) interfaces the special purpose logic 608 (e.g., integrated graphics logic), the set of shared cache unit(s) circuitry 606, and the system agent unit circuitry 610, alternative examples use any number of well-known techniques for interfacing such units. In some examples, coherency is maintained between one or more of the shared cache unit(s) circuitry 606 and cores 602(A)-(N). In some examples, interface controller units circuitry 616 couple the cores 602 to one or more other devices 618 such as one or more I/O devices, storage, one or more communication devices (e.g., wireless networking, wired networking, etc.), etc.

In some examples, one or more of the cores 602(A)-(N) are capable of multi-threading. The system agent unit circuitry 610 includes those components coordinating and operating cores 602(A)-(N). The system agent unit circuitry 610 may include, for example, power control unit (PCU) circuitry and/or display unit circuitry (not shown). The PCU may be or may include logic and components needed for regulating the power state of the cores 602(A)-(N) and/or the special purpose logic 608 (e.g., integrated graphics logic). The display unit circuitry is for driving one or more externally connected displays.

The cores 602(A)-(N) may be homogenous in terms of instruction set architecture (ISA). Alternatively, the cores 602(A)-(N) may be heterogeneous in terms of ISA; that is, a subset of the cores 602(A)-(N) may be capable of executing an ISA, while other cores may be capable of executing only a subset of that ISA or another ISA.

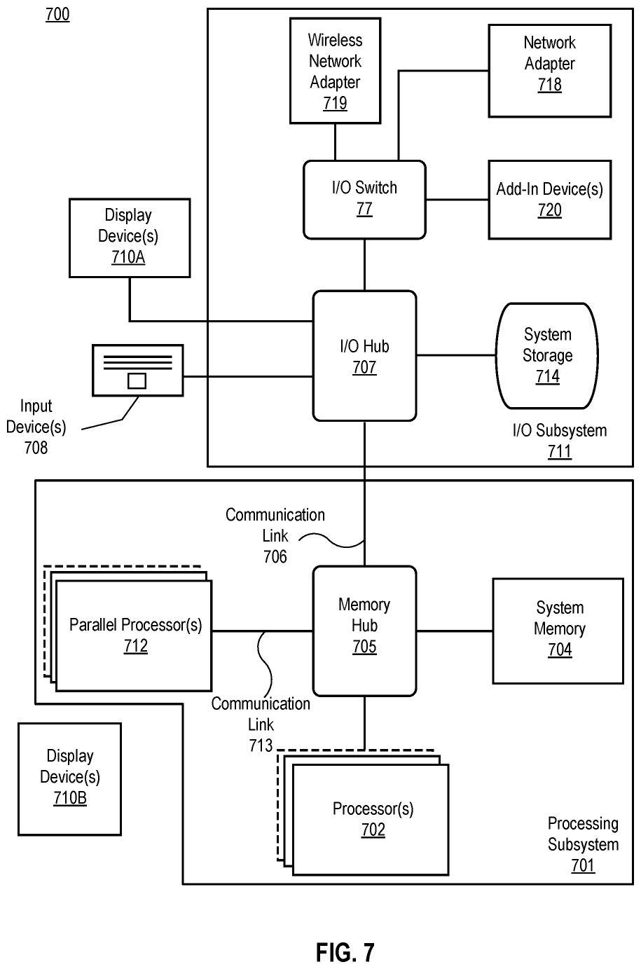

FIG. 7 is a block diagram illustrating a computing system 700 configured to implement one or more aspects of the examples described herein. The computing system 700 includes a processing subsystem 701 having one or more processor(s) 702 and a system memory 704 communicating via an interconnection path that may include a memory hub 705. The memory hub 705 may be a separate component within a chipset component or may be integrated within the one or more processor(s) 702. The memory hub 705 couples with an I/O subsystem 711 via a communication link 706. The I/O subsystem 711 includes an I/O hub 707 that can enable the computing system 700 to receive input from one or more input device(s) 708. Additionally, the I/O hub 707 can enable a display controller, which may be included in the one or more processor(s) 702, to provide outputs to one or more display device(s) 710A. In some examples the one or more display device(s) 710A coupled with the I/O hub 707 can include a local, internal, or embedded display device.

The processing subsystem 701, for example, includes one or more parallel processor(s) 712 coupled to memory hub 705 via a bus or other communication link 713. The communication link 713 may be one of any number of standards-based communication link technologies or protocols, such as, but not limited to PCI Express, or may be a vendor specific communications interface or communications fabric. The one or more parallel processor(s) 712 may form a computationally focused parallel or vector processing system that can include a large number of processing cores and/or processing clusters, such as a many integrated core (MIC) processor. For example, the one or more parallel processor(s) 712 form a graphics processing subsystem that can output pixels to one of the one or more display device(s) 710A coupled via the I/O hub 707. The one or more parallel processor(s) 712 can also include a display controller and display interface (not shown) to enable a direct connection to one or more display device(s) 710B.

Within the I/O subsystem 711, a system storage unit 714 can connect to the I/O hub 707 to provide a storage mechanism for the computing system 700. An I/O switch 716 can be used to provide an interface mechanism to enable connections between the I/O hub 707 and other components, such as a network adapter 718 and/or wireless network adapter 719 that may be integrated into the platform, and various other devices that can be added via one or more add-in device(s) 720. The add-in device(s) 720 may also include, for example, one or more external graphics processor devices, graphics cards, and/or compute accelerators. The network adapter 718 can be an Ethernet adapter or another wired network adapter. The wireless network adapter 719 can include one or more of a Wi-Fi, Bluetooth, near field communication (NFC), or other network device that includes one or more wireless radios.

The computing system 700 can include other components not explicitly shown, including USB or other port connections, optical storage drives, video capture devices, and the like, which may also be connected to the I/O hub 707. Communication paths interconnecting the various components in FIG. 7 may be implemented using any suitable protocols, such as PCI (Peripheral Component Interconnect) based protocols (e.g., PCI-Express), or any other bus or point-to-point communication interfaces and/or protocol(s), such as the NVLink high-speed interconnect, Compute Express Link™ (CXL™) (e.g., CXLmem), Infinity Fabric (IF), Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Intel QuickPath Interconnect (QPI), Intel Ultra Path Interconnect (UPI), Intel On-Chip System Fabric (IOSF), Omnipath, HyperTransport, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof, or wired or wireless interconnect protocols known in the art. In some examples, data can be copied or stored to virtualized storage nodes using a protocol such as non-volatile memory express (NVMe) over Fabrics (NVMe-oF) or NVMe.

The one or more parallel processor(s) 712 may incorporate circuitry optimized for graphics and video processing, including, for example, video output circuitry, and constitutes a graphics processing unit (GPU). Alternatively or additionally, the one or more parallel processor(s) 712 can incorporate circuitry optimized for general purpose processing, while preserving the underlying computational architecture, described in greater detail herein. Components of the computing system 700 may be integrated with one or more other system elements on a single integrated circuit. For example, the one or more parallel processor(s) 712, memory hub 705, processor(s) 702, and I/O hub 707 can be integrated into a system on chip (SoC) integrated circuit. Alternatively, the components of the computing system 700 can be integrated into a single package to form a system in package (SIP) configuration. In some examples at least a portion of the components of the computing system 700 can be integrated into a multi-chip module (MCM), which can be interconnected with other multi-chip modules into a modular computing system.

It will be appreciated that the computing system 700 shown herein is illustrative and that variations and modifications are possible. The connection topology, including the number and arrangement of bridges, the number of processor(s) 702, and the number of parallel processor(s) 712, may be modified as desired. For instance, system memory 704 can be connected to the processor(s) 702 directly rather than through a bridge, while other devices communicate with system memory 704 via the memory hub 705 and the processor(s) 702. In other alternative topologies, the parallel processor(s) 712 are connected to the I/O hub 707 or directly to one of the one or more processor(s) 702, rather than to the memory hub 705. In other examples, the I/O hub 707 and memory hub 705 may be integrated into a single chip. It is also possible that two or more sets of processor(s) 702 are attached via multiple sockets, which can couple with two or more instances of the parallel processor(s) 712.

Some of the particular components shown herein are optional and may not be included in all implementations of the computing system 700. For example, any number of add-in cards or peripherals may be supported, or some components may be eliminated. Furthermore, some architectures may use different terminology for components similar to those illustrated in FIG. 7. For example, the memory hub 705 may be referred to as a Northbridge in some architectures, while the I/O hub 707 may be referred to as a Southbridge.

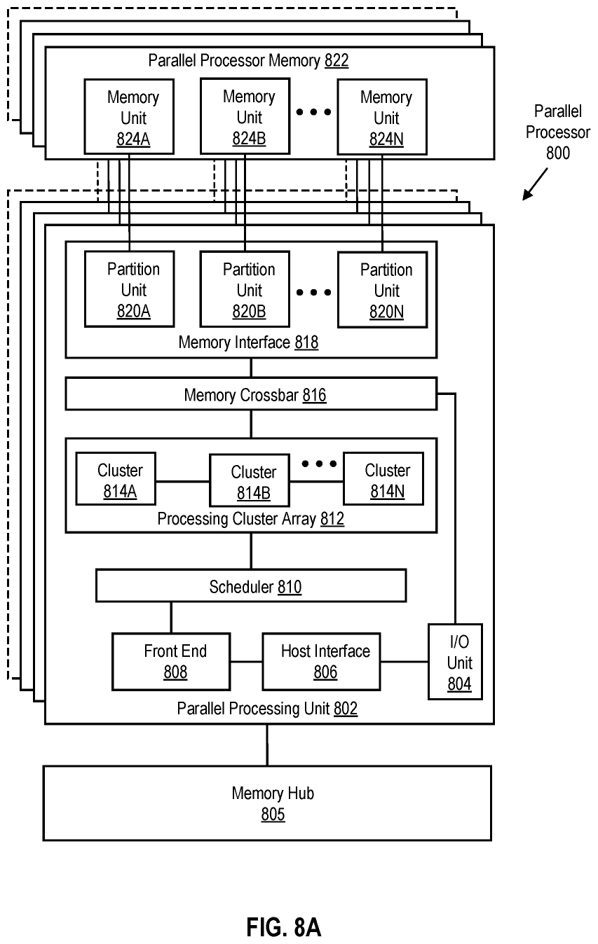

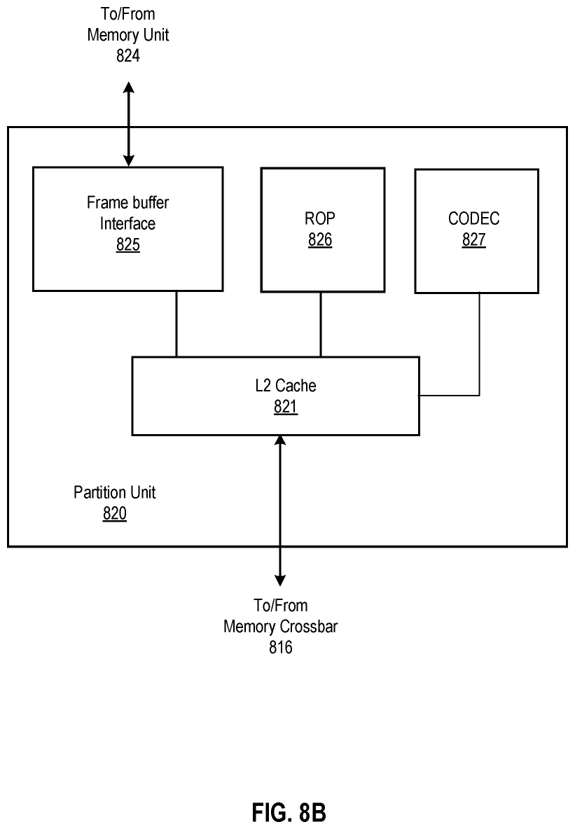

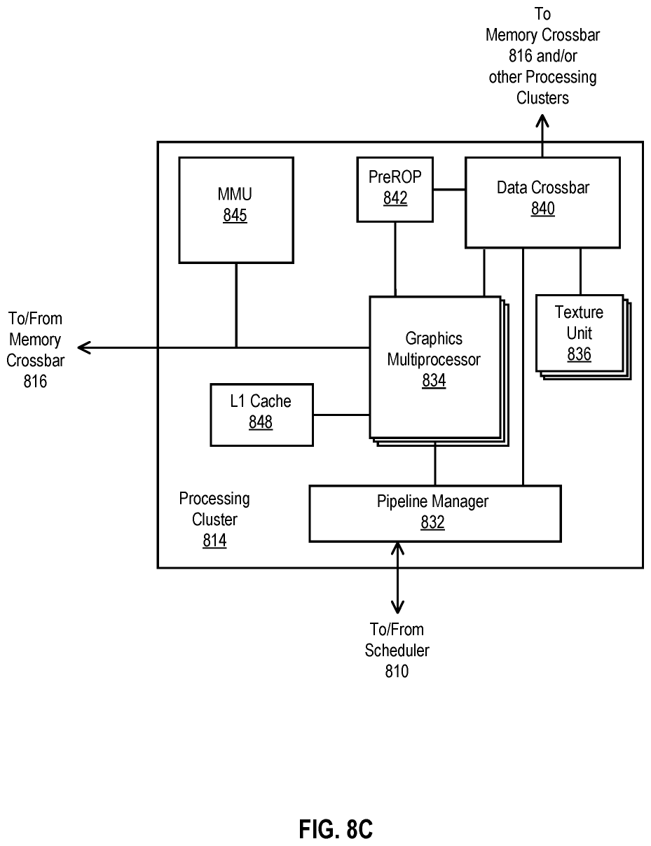

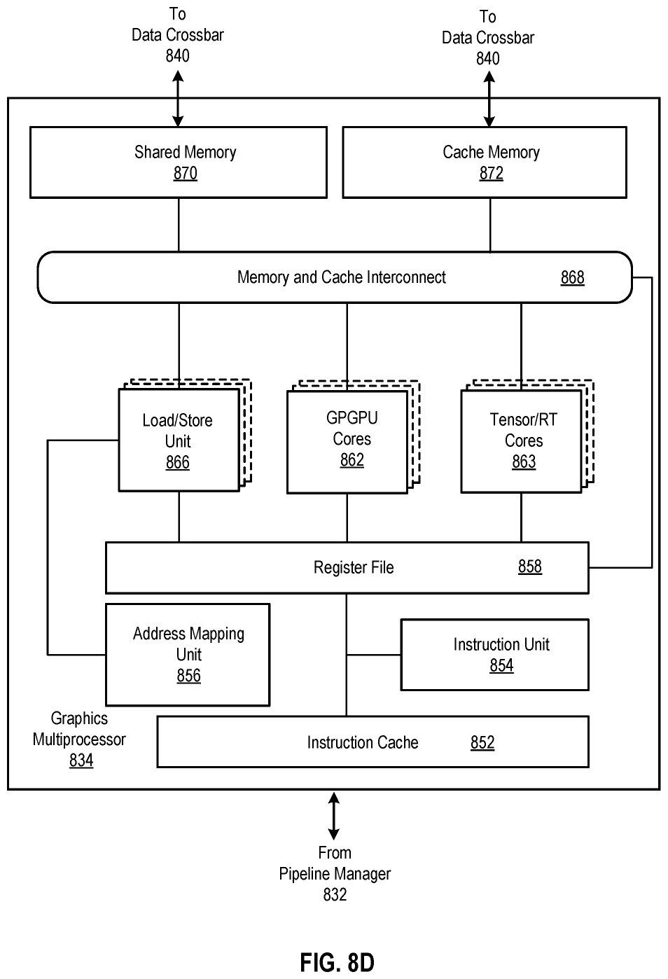

FIG. 8A illustrates examples of a parallel processor 800. The parallel processor 800 may be a GPU, GPGPU or the like as described herein. The various components of the parallel processor 800 may be implemented using one or more integrated circuit devices, such as programmable processors, application specific integrated circuits (ASICs), or field programmable gate arrays (FPGA). The illustrated parallel processor 800 may be one or more of the parallel processor(s) 712 shown in FIG. 7.

The parallel processor 800 includes a parallel processing unit 802. The parallel processing unit includes an I/O unit 804 that enables communication with other devices, including other instances of the parallel processing unit 802. The I/O unit 804 may be directly connected to other devices. For instance, the I/O unit 804 connects with other devices via the use of a hub or switch interface, such as memory hub 705. The connections between the memory hub 705 and the I/O unit 804 form a communication link 713. Within the parallel processing unit 802, the I/O unit 804 connects with a host interface 806 and a memory crossbar 816, where the host interface 806 receives commands directed to performing processing operations and the memory crossbar 816 receives commands directed to performing memory operations.

When the host interface 806 receives a command buffer via the I/O unit 804, the host interface 806 can direct work operations to perform those commands to a front end 808. In some examples the front end 808 couples with a scheduler 810, which is configured to distribute commands or other work items to a processing cluster array 812. The scheduler 810 ensures that the processing cluster array 812 is properly configured and in a valid state before tasks are distributed to the processing clusters of the processing cluster array 812. The scheduler 810 may be implemented via firmware logic executing on a microcontroller. The microcontroller implemented scheduler 810 is configurable to perform complex scheduling and work distribution operations at coarse and fine granularity, enabling rapid preemption and context switching of threads executing on the processing cluster array 812. Preferably, the host software can prove workloads for scheduling on the processing cluster array 812 via one of multiple graphics processing doorbells. In other examples, polling for new workloads or interrupts can be used to identify or indicate availability of work to perform. The workloads can then be automatically distributed across the processing cluster array 812 by the scheduler 810 logic within the scheduler microcontroller.

The processing cluster array 812 can include up to “N” processing clusters (e.g., cluster 814A, cluster 814B, through cluster 814N). Each cluster 814A-814N of the processing cluster array 812 can execute a large number of concurrent threads. The scheduler 810 can allocate work to the clusters 814A-814N of the processing cluster array 812 using various scheduling and/or work distribution algorithms, which may vary depending on the workload arising for each type of program or computation. The scheduling can be handled dynamically by the scheduler 810 or can be assisted in part by compiler logic during compilation of program logic configured for execution by the processing cluster array 812. Optionally, different clusters 814A-814N of the processing cluster array 812 can be allocated for processing different types of programs or for performing different types of computations.

The processing cluster array 812 can be configured to perform various types of parallel processing operations. For example, the processing cluster array 812 is configured to perform general-purpose parallel compute operations. For example, the processing cluster array 812 can include logic to execute processing tasks including filtering of video and/or audio data, performing modeling operations, including physics operations, and performing data transformations.

The processing cluster array 812 is configured to perform parallel graphics processing operations. In such examples in which the parallel processor 800 is configured to perform graphics processing operations, the processing cluster array 812 can include additional logic to support the execution of such graphics processing operations, including, but not limited to texture sampling logic to perform texture operations, as well as tessellation logic and other vertex processing logic. Additionally, the processing cluster array 812 can be configured to execute graphics processing related shader programs such as, but not limited to vertex shaders, tessellation shaders, geometry shaders, and pixel shaders. The parallel processing unit 802 can transfer data from system memory via the I/O unit 804 for processing. During processing the transferred data can be stored to on-chip memory (e.g., parallel processor memory 822) during processing, then written back to system memory.

In examples in which the parallel processing unit 802 is used to perform graphics processing, the scheduler 810 may be configured to divide the processing workload into approximately equal sized tasks, to better enable distribution of the graphics processing operations to multiple clusters 814A-814N of the processing cluster array 812. In some of these examples, portions of the processing cluster array 812 can be configured to perform different types of processing. For example, a first portion may be configured to perform vertex shading and topology generation, a second portion may be configured to perform tessellation and geometry shading, and a third portion may be configured to perform pixel shading or other screen space operations, to produce a rendered image for display. Intermediate data produced by one or more of the clusters 814A-814N may be stored in buffers to allow the intermediate data to be transmitted between clusters 814A-814N for further processing.

During operation, the processing cluster array 812 can receive processing tasks to be executed via the scheduler 810, which receives commands defining processing tasks from front end 808. For graphics processing operations, processing tasks can include indices of data to be processed, e.g., surface (patch) data, primitive data, vertex data, and/or pixel data, as well as state parameters and commands defining how the data is to be processed (e.g., what program is to be executed). The scheduler 810 may be configured to fetch the indices corresponding to the tasks or may receive the indices from the front end 808. The front end 808 can be configured to ensure the processing cluster array 812 is configured to a valid state before the workload specified by incoming command buffers (e.g., batch-buffers, push buffers, etc.) is initiated.

Each of the one or more instances of the parallel processing unit 802 can couple with parallel processor memory 822. The parallel processor memory 822 can be accessed via the memory crossbar 816, which can receive memory requests from the processing cluster array 812 as well as the I/O unit 804. The memory crossbar 816 can access the parallel processor memory 822 via a memory interface 818. The memory interface 818 can include multiple partition units (e.g., partition unit 820A, partition unit 820B, through partition unit 820N) that can each couple to a portion (e.g., memory unit) of parallel processor memory 822. The number of partition units 820A-820N may be configured to be equal to the number of memory units, such that a first partition unit 820A has a corresponding first memory unit 824A, a second partition unit 820B has a corresponding second memory unit 824B, and an Nth partition unit 820N has a corresponding Nth memory unit 824N. In other examples, the number of partition units 820A-820N may not be equal to the number of memory devices.

The memory units 824A-824N can include various types of memory devices, including dynamic random-access memory (DRAM) or graphics random access memory, such as synchronous graphics random access memory (SGRAM), including graphics double data rate (GDDR) memory. Optionally, the memory units 824A-824N may also include 3D stacked memory, including but not limited to high bandwidth memory (HBM). Persons skilled in the art will appreciate that the specific implementation of the memory units 824A-824N can vary and can be selected from one of various conventional designs. Render targets, such as frame buffers or texture maps may be stored across the memory units 824A-824N, allowing partition units 820A-820N to write portions of each render target in parallel to efficiently use the available bandwidth of parallel processor memory 822. In some examples, a local instance of the parallel processor memory 822 may be excluded in favor of a unified memory design that utilizes system memory in conjunction with local cache memory.

Optionally, any one of the clusters 814A-814N of the processing cluster array 812 has the ability to process data that will be written to any of the memory units 824A-824N within parallel processor memory 822. The memory crossbar 816 can be configured to transfer the output of each cluster 814A-814N to any partition unit 820A-820N or to another cluster 814A-814N, which can perform additional processing operations on the output. Each cluster 814A-814N can communicate with the memory interface 818 through the memory crossbar 816 to read from or write to various external memory devices. In one of the examples with the memory crossbar 816 the memory crossbar 816 has a connection to the memory interface 818 to communicate with the I/O unit 804, as well as a connection to a local instance of the parallel processor memory 822, enabling the processing units within the different processing clusters 814A-814N to communicate with system memory or other memory that is not local to the parallel processing unit 802. Generally, the memory crossbar 816 may, for example, be able to use virtual channels to separate traffic streams between the clusters 814A-814N and the partition units 820A-820N.

While a single instance of the parallel processing unit 802 is illustrated within the parallel processor 800, any number of instances of the parallel processing unit 802 can be included. For example, multiple instances of the parallel processing unit 802 can be provided on a single add-in card, or multiple add-in cards can be interconnected. For example, the parallel processor 800 can be an add-in device, such as add-in device 720 of FIG. 7, which may be a graphics card such as a discrete graphics card that includes one or more GPUs, one or more memory devices, and device-to-device or network or fabric interfaces. The different instances of the parallel processing unit 802 can be configured to inter-operate even if the different instances have different numbers of processing cores, different amounts of local parallel processor memory, and/or other configuration differences. Optionally, some instances of the parallel processing unit 802 can include higher precision floating point units relative to other instances. Systems incorporating one or more instances of the parallel processing unit 802 or the parallel processor 800 can be implemented in a variety of configurations and form factors, including but not limited to desktop, laptop, or handheld personal computers, servers, workstations, game consoles, and/or embedded systems. An orchestrator can form composite nodes for workload performance using one or more of: disaggregated processor resources, cache resources, memory resources, storage resources, and networking resources.

In some examples, the parallel processing unit 802 can be partitioned into multiple instances. Those multiple instances can be configured to execute workloads associated with different clients in an isolated manner, enabling a pre-determined quality of service to be provided for each client. For example, each cluster 814A-814N can be compartmentalized and isolated from other clusters, allowing the processing cluster array 812 to be divided into multiple compute partitions or instances. In such configuration, workloads that execute on an isolated partition are protected from faults or errors associated with a different workload that executes on a different partition. The partition units 820A-820N can be configured to enable a dedicated and/or isolated path to memory for the clusters 814A-814N associated with the respective compute partitions. This datapath isolation enables the compute resources within a partition can communicate with one or more assigned memory units 824A-824N without being subjected to inference by the activities of other partitions.

FIG. 8B is a block diagram of a partition unit 820. The partition unit 820 may be an instance of one of the partition units 820A-820N of FIG. 8A. As illustrated, the partition unit 820 includes an L2 cache 821, a frame buffer interface 825, and a ROP 826 (raster operations unit). The L2 cache 821 is a read/write cache that is configured to perform load and store operations received from the memory crossbar 816 and ROP 826. Read misses and urgent write-back requests are output by L2 cache 821 to frame buffer interface 825 for processing. Updates can also be sent to the frame buffer via the frame buffer interface 825 for processing. In some examples the frame buffer interface 825 interfaces with one of the memory units in parallel processor memory, such as the memory units 824A-824N of FIG. 8A (e.g., within parallel processor memory 822). The partition unit 820 may additionally or alternatively also interface with one of the memory units in parallel processor memory via a memory controller (not shown).

In graphics applications, the ROP 826 is a processing unit that performs raster operations such as stencil, z test, blending, and the like. The ROP 826 then outputs processed graphics data that is stored in graphics memory. In some examples the ROP 826 includes or couples with a CODEC 827 that includes compression logic to compress depth or color data that is written to memory or the L2 cache 821 and decompress depth or color data that is read from memory or the L2 cache 821. The compression logic can be lossless compression logic that makes use of one or more of multiple compression algorithms. The type of compression that is performed by the CODEC 827 can vary based on the statistical characteristics of the data to be compressed. For example, in some examples, delta color compression is performed on depth and color data on a per-tile basis. In some examples the CODEC 827 includes compression and decompression logic that can compress and decompress compute data associated with machine learning operations. The CODEC 827 can, for example, compress sparse matrix data for sparse machine learning operations. The CODEC 827 can also compress sparse matrix data that is encoded in a sparse matrix format (e.g., coordinate list encoding (COO), compressed sparse row (CSR), compress sparse column (CSC), etc.) to generate compressed and encoded sparse matrix data. The compressed and encoded sparse matrix data can be decompressed and/or decoded before being processed by processing elements or the processing elements can be configured to consume compressed, encoded, or compressed and encoded data for processing.

The ROP 826 may be included within each processing cluster (e.g., cluster 814A-814N of FIG. 8A) instead of within the partition unit 820. In such example, read and write requests for pixel data are transmitted over the memory crossbar 816 instead of pixel fragment data. The processed graphics data may be displayed on a display device, such as one of the one or more display device(s) 710A-710B of FIG. 7, routed for further processing by the processor(s) 702, or routed for further processing by one of the processing entities within the parallel processor 800 of FIG. 8A.

FIG. 8C is a block diagram of a processing cluster 814 within a parallel processing unit. For example, the processing cluster is an instance of one of the processing clusters 814A-814N of FIG. 8A. The processing cluster 814 can be configured to execute many threads in parallel, where the term “thread” refers to an instance of a particular program executing on a particular set of input data. Optionally, single-instruction, multiple-data (SIMD) instruction issue techniques may be used to support parallel execution of a large number of threads without providing multiple independent instruction units. Alternatively, single-instruction, multiple-thread (SIMT) techniques may be used to support parallel execution of a large number of generally synchronized threads, using a common instruction unit configured to issue instructions to a set of processing engines within each one of the processing clusters. Unlike a SIMD execution regime, where all processing engines typically execute identical instructions, SIMT execution allows different threads to more readily follow divergent execution paths through a given thread program. Persons skilled in the art will understand that a SIMD processing regime represents a functional subset of a SIMT processing regime.

Operation of the processing cluster 814 can be controlled via a pipeline manager 832 that distributes processing tasks to SIMT parallel processors. The pipeline manager 832 receives instructions from the scheduler 810 of FIG. 8A and manages execution of those instructions via a graphics multiprocessor 834 and/or a texture unit 836. The illustrated graphics multiprocessor 834 is an exemplary instance of a SIMT parallel processor. However, various types of SIMT parallel processors of differing architectures may be included within the processing cluster 814. One or more instances of the graphics multiprocessor 834 can be included within a processing cluster 814. The graphics multiprocessor 834 can process data and a data crossbar 840 can be used to distribute the processed data to one of multiple possible destinations, including other shader units. The pipeline manager 832 can facilitate the distribution of processed data by specifying destinations for processed data to be distributed via the data crossbar 840.

Each graphics multiprocessor 834 within the processing cluster 814 can include an identical set of functional execution logic (e.g., arithmetic logic units, load-store units, etc.). The functional execution logic can be configured in a pipelined manner in which new instructions can be issued before previous instructions are complete. The functional execution logic supports a variety of operations including integer and floating-point arithmetic, comparison operations, Boolean operations, bit-shifting, and computation of various algebraic functions. The same functional-unit hardware could be leveraged to perform different operations and any combination of functional units may be present.

The instructions transmitted to the processing cluster 814 constitute a thread. A set of threads executing across the set of parallel processing engines is a thread group. A thread group executes the same program on different input data. Each thread within a thread group can be assigned to a different processing engine within a graphics multiprocessor 834. A thread group may include fewer threads than the number of processing engines within the graphics multiprocessor 834. When a thread group includes fewer threads than the number of processing engines, one or more of the processing engines may be idle during cycles in which that thread group is being processed. A thread group may also include more threads than the number of processing engines within the graphics multiprocessor 834. When the thread group includes more threads than the number of processing engines within the graphics multiprocessor 834, processing can be performed over consecutive clock cycles. Optionally, multiple thread groups can be executed concurrently on the graphics multiprocessor 834.

The graphics multiprocessor 834 may include an internal cache memory to perform load and store operations. Optionally, the graphics multiprocessor 834 can forego an internal cache and use a cache memory (e.g., level 1 (L1) cache 848) within the processing cluster 814. Each graphics multiprocessor 834 also has access to level 2 (L2) caches within the partition units (e.g., partition units 820A-820N of FIG. 8A) that are shared among all processing clusters 814 and may be used to transfer data between threads. The graphics multiprocessor 834 may also access off-chip global memory, which can include one or more of local parallel processor memory and/or system memory. Any memory external to the parallel processing unit 802 may be used as global memory. Embodiments in which the processing cluster 814 includes multiple instances of the graphics multiprocessor 834 can share common instructions and data, which may be stored in the L1 cache 848.

Each processing cluster 814 may include an MMU 845 (memory management unit) that is configured to map virtual addresses into physical addresses. In other examples, one or more instances of the MMU 845 may reside within the memory interface 818 of FIG. 8A. The MMU 845 includes a set of page table entries (PTEs) used to map a virtual address to a physical address of a tile and optionally a cache line index. The MMU 845 may include address translation lookaside buffers (TLB) or caches that may reside within the graphics multiprocessor 834 or the L1 cache 848 of processing cluster 814. The physical address is processed to distribute surface data access locality to allow efficient request interleaving among partition units. The cache line index may be used to determine whether a request for a cache line is a hit or miss.

In graphics and computing applications, a processing cluster 814 may be configured such that each graphics multiprocessor 834 is coupled to a texture unit 836 for performing texture mapping operations, e.g., determining texture sample positions, reading texture data, and filtering the texture data. Texture data is read from an internal texture L1 cache (not shown) or in some examples from the L1 cache within graphics multiprocessor 834 and is fetched from an L2 cache, local parallel processor memory, or system memory, as needed. Each graphics multiprocessor 834 outputs processed tasks to the data crossbar 840 to provide the processed task to another processing cluster 814 for further processing or to store the processed task in an L2 cache, local parallel processor memory, or system memory via the memory crossbar 816. A preROP 842 (pre-raster operations unit) is configured to receive data from graphics multiprocessor 834, direct data to ROP units, which may be located with partition units as described herein (e.g., partition units 820A-820N of FIG. 8A). The preROP 842 unit can perform optimizations for color blending, organize pixel color data, and perform address translations.

It will be appreciated that the core architecture described herein is illustrative and that variations and modifications are possible. Any number of processing units, e.g., graphics multiprocessor 834, texture units 836, preROPs 842, etc., may be included within a processing cluster 814. Further, while only one processing cluster 814 is shown, a parallel processing unit as described herein may include any number of instances of the processing cluster 814. Optionally, each processing cluster 814 can be configured to operate independently of other processing clusters 814 using separate and distinct processing units, L1 caches, L2 caches, etc.

FIG. 8D shows an example of the graphics multiprocessor 834 in which the graphics multiprocessor 834 couples with the pipeline manager 832 of the processing cluster 814. The graphics multiprocessor 834 has an execution pipeline including but not limited to an instruction cache 852, an instruction unit 854, an address mapping unit 856, a register file 858, one or more general purpose graphics processing unit (GPGPU) cores 862, and one or more load/store units 866. The GPGPU cores 862 and load/store units 866 are coupled with cache memory 872 and shared memory 870 via a memory and cache interconnect 868. The graphics multiprocessor 834 may additionally include tensor and/or ray-tracing cores 863 that include hardware logic to accelerate matrix and/or ray-tracing operations.

The instruction cache 852 may receive a stream of instructions to execute from the pipeline manager 832. The instructions are cached in the instruction cache 852 and dispatched for execution by the instruction unit 854. The instruction unit 854 can dispatch instructions as thread groups (e.g., warps), with each thread of the thread group assigned to a different execution unit within GPGPU core 862. An instruction can access any of a local, shared, or global address space by specifying an address within a unified address space. The address mapping unit 856 can be used to translate addresses in the unified address space into a distinct memory address that can be accessed by the load/store units 866.

The register file 858 provides a set of registers for the functional units of the graphics multiprocessor 834. The register file 858 provides temporary storage for operands connected to the data paths of the functional units (e.g., GPGPU cores 862, load/store units 866) of the graphics multiprocessor 834. The register file 858 may be divided between each of the functional units such that each functional unit is allocated a dedicated portion of the register file 858. For example, the register file 858 may be divided between the different warps being executed by the graphics multiprocessor 834.

The GPGPU cores 862 can each include floating point units (FPUs) and/or integer arithmetic logic units (ALUs) that are used to execute instructions of the graphics multiprocessor 834. In some implementations, the GPGPU cores 862 can include hardware logic that may otherwise reside within the tensor and/or ray-tracing cores 863. The GPGPU cores 862 can be similar in architecture or can differ in architecture. For example and in some examples, a first portion of the GPGPU cores 862 include a single precision FPU and an integer ALU while a second portion of the GPGPU cores include a double precision FPU. Optionally, the FPUs can implement the IEEE 754-2008 standard for floating point arithmetic or enable variable precision floating point arithmetic. The graphics multiprocessor 834 can additionally include one or more fixed function or special function units to perform specific functions such as copy rectangle or pixel blending operations. One or more of the GPGPU cores can also include fixed or special function logic.

The GPGPU cores 862 may include SIMD logic capable of performing a single instruction on multiple sets of data. Optionally, GPGPU cores 862 can physically execute SIMD4, SIMD8, and SIMD16 instructions and logically execute SIMD1, SIMD2, and SIMD32 instructions. The SIMD instructions for the GPGPU cores can be generated at compile time by a shader compiler or automatically generated when executing programs written and compiled for single program multiple data (SPMD) or SIMT architectures. Multiple threads of a program configured for the SIMT execution model can be executed via a single SIMD instruction. For example and in some examples, eight SIMT threads that perform the same or similar operations can be executed in parallel via a single SIMD8 logic unit.

The memory and cache interconnect 868 is an interconnect network that connects each of the functional units of the graphics multiprocessor 834 to the register file 858 and to the shared memory 870. For example, the memory and cache interconnect 868 is a crossbar interconnect that allows the load/store unit 866 to implement load and store operations between the shared memory 870 and the register file 858. The register file 858 can operate at the same frequency as the GPGPU cores 862, thus data transfer between the GPGPU cores 862 and the register file 858 is very low latency. The shared memory 870 can be used to enable communication between threads that execute on the functional units within the graphics multiprocessor 834. The cache memory 872 can be used as a data cache for example, to cache texture data communicated between the functional units and the texture unit 836. The shared memory 870 can also be used as a program managed cached. The shared memory 870 and the cache memory 872 can couple with the data crossbar 840 to enable communication with other components of the processing cluster. Threads executing on the GPGPU cores 862 can programmatically store data within the shared memory in addition to the automatically cached data that is stored within the cache memory 872.

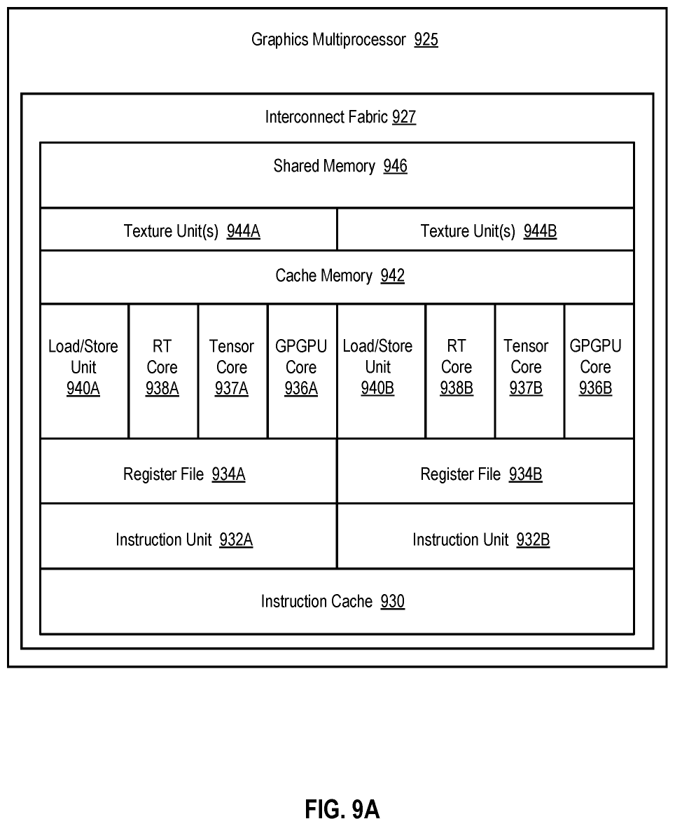

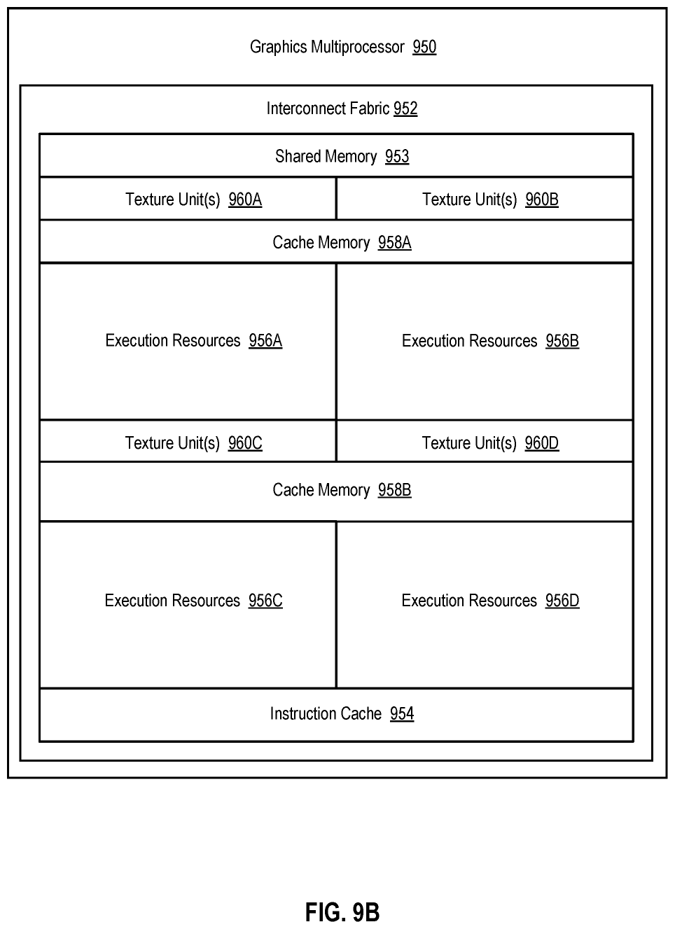

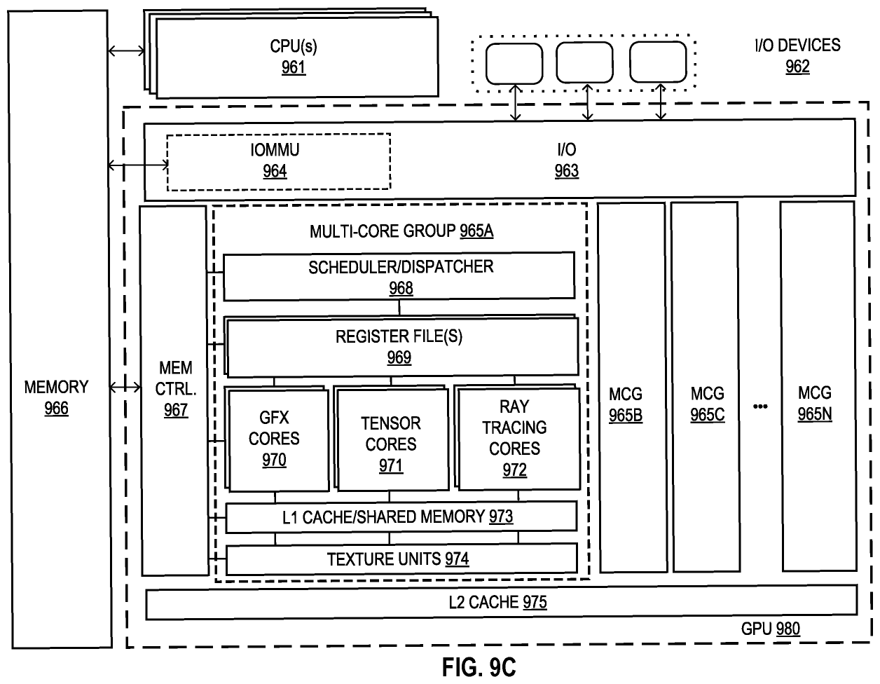

FIGS. 9A-9C illustrate additional graphics multiprocessors, according to examples. FIG. 9A-9B illustrate graphics multiprocessors 925, 950, which are related to the graphics multiprocessor 834 of FIG. 8C and may be used in place of one of those. Therefore, the disclosure of any features in combination with the graphics multiprocessor 834 herein also discloses a corresponding combination with the graphics multiprocessor(s) 925, 950, but is not limited to such. FIG. 9C illustrates a graphics processing unit (GPU) 980 which includes dedicated sets of graphics processing resources arranged into multi-core groups 965A-965N, which correspond to the graphics multiprocessors 925, 950. The illustrated graphics multiprocessors 925, 950 and the multi-core groups 965A-965N can be streaming multiprocessors (SM) capable of simultaneous execution of a large number of execution threads.

The graphics multiprocessor 925 of FIG. 9A includes multiple additional instances of execution resource units relative to the graphics multiprocessor 834 of FIG. 8D. For example, the graphics multiprocessor 925 can include multiple instances of the instruction unit 932A-932B, register file 934A-934B, and texture unit(s) 944A-944B. The graphics multiprocessor 925 also includes multiple sets of graphics or compute execution units (e.g., GPGPU core 936A-936B, tensor core 937A-937B, ray-tracing core 938A-938B) and multiple sets of load/store units 940A-940B. The execution resource units have a common instruction cache 930, texture and/or data cache memory 942, and shared memory 946.

The various components can communicate via an interconnect fabric 927. The interconnect fabric 927 may include one or more crossbar switches to enable communication between the various components of the graphics multiprocessor 925. The interconnect fabric 927 may be a separate, high-speed network fabric layer upon which each component of the graphics multiprocessor 925 is stacked. The components of the graphics multiprocessor 925 communicate with remote components via the interconnect fabric 927. For example, the cores 936A-936B, 937A-937B, and 938A-938B can each communicate with shared memory 946 via the interconnect fabric 927. The interconnect fabric 927 can arbitrate communication within the graphics multiprocessor 925 to ensure a fair bandwidth allocation between components.

The graphics multiprocessor 950 of FIG. 9B includes multiple sets of execution resources 956A-956D, where each set of execution resource includes multiple instruction units, register files, GPGPU cores, and load store units, as illustrated in FIG. 8D and FIG. 9A. The execution resources 956A-956D can work in concert with texture unit(s) 960A-960D for texture operations, while sharing an instruction cache 954, and shared memory 953. For example, the execution resources 956A-956D can share an instruction cache 954 and shared memory 953, as well as multiple instances of a texture and/or data cache memory 958A-958B. The various components can communicate via an interconnect fabric 952 similar to the interconnect fabric 927 of FIG. 9A.

Persons skilled in the art will understand that the architecture described in FIGS. 1, 8A-8D, and 9A-9B are descriptive and not limiting as to the scope of the present examples. Thus, the techniques described herein may be implemented on any properly configured processing unit, including, without limitation, one or more mobile application processors, one or more desktop or server central processing units (CPUs) including multi-core CPUs, one or more parallel processing units, such as the parallel processing unit 802 of FIG. 8A, as well as one or more graphics processors or special purpose processing units, without departure from the scope of the examples described herein.

The parallel processor or GPGPU as described herein may be communicatively coupled to host/processor cores to accelerate graphics operations, machine-learning operations, pattern analysis operations, and various general-purpose GPU (GPGPU) functions. The GPU may be communicatively coupled to the host processor/cores over a bus or other interconnect (e.g., a high-speed interconnect such as PCIe, NVLink, or other known protocols, standardized protocols, or proprietary protocols). In other examples, the GPU may be integrated on the same package or chip as the cores and communicatively coupled to the cores over an internal processor bus/interconnect (e.g., internal to the package or chip). Regardless of the manner in which the GPU is connected, the processor cores may allocate work to the GPU in the form of sequences of commands/instructions contained in a work descriptor. The GPU then uses dedicated circuitry/logic for efficiently processing these commands/instructions.

FIG. 9C illustrates a graphics processing unit (GPU) 980 which includes dedicated sets of graphics processing resources arranged into multi-core groups 965A-965N. While the details of only a single multi-core group 965A are provided, it will be appreciated that the other multi-core groups 965B-965N may be equipped with the same or similar sets of graphics processing resources. Details described with respect to the multi-core groups 965A-965N may also apply to any graphics multiprocessor 834, 925, 950 described herein.

As illustrated, a multi-core group 965A may include a set of graphics cores 970, a set of tensor cores 971, and a set of ray tracing cores 972. A scheduler/dispatcher 968 schedules and dispatches the graphics threads for execution on the various cores 970, 971, 972. A set of register files 969 store operand values used by the cores 970, 971, 972 when executing the graphics threads. These may include, for example, integer registers for storing integer values, floating point registers for storing floating point values, vector registers for storing packed data elements (integer and/or floating-point data elements) and tile registers for storing tensor/matrix values. The tile registers may be implemented as combined sets of vector registers.

One or more combined level 1 (L1) caches and shared memory units 973 store graphics data such as texture data, vertex data, pixel data, ray data, bounding volume data, etc., locally within each multi-core group 965A. One or more texture units 974 can also be used to perform texturing operations, such as texture mapping and sampling. A Level 2 (L2) cache 975 shared by all or a subset of the multi-core groups 965A-965N stores graphics data and/or instructions for multiple concurrent graphics threads. As illustrated, the L2 cache 975 may be shared across a plurality of multi-core groups 965A-965N. One or more memory controllers 967 couple the GPU 980 to a memory 966 which may be a system memory (e.g., DRAM) and/or a dedicated graphics memory (e.g., GDDR6 memory).

Input/output (I/O) circuitry 963 couples the GPU 980 to one or more I/O devices 962 such as digital signal processors (DSPs), network controllers, or user input devices. An on-chip interconnect may be used to couple the I/O devices 962 to the GPU 980 and memory 966. One or more I/O memory management units (IOMMUs) 964 of the I/O circuitry 963 couple the I/O devices 962 directly to the system memory 966. Optionally, the IOMMU 964 manages multiple sets of page tables to map virtual addresses to physical addresses in system memory 966. The I/O devices 962, CPU(s) 961, and GPU(s) 980 may then share the same virtual address space.

In one implementation of the IOMMU 964, the IOMMU 964 supports virtualization. In this case, it may manage a first set of page tables to map guest/graphics virtual addresses to guest/graphics physical addresses and a second set of page tables to map the guest/graphics physical addresses to system/host physical addresses (e.g., within system memory 966). The base addresses of each of the first and second sets of page tables may be stored in control registers and swapped out on a context switch (e.g., so that the new context is provided with access to the relevant set of page tables). While not illustrated in FIG. 9C, each of the cores 970, 971, 972 and/or multi-core groups 965A-965N may include translation lookaside buffers (TLBs) to cache guest virtual to guest physical translations, guest physical to host physical translations, and guest virtual to host physical translations.

The CPU(s) 961, GPUs 980, and I/O devices 962 may be integrated on a single semiconductor chip and/or chip package. The illustrated memory 966 may be integrated on the same chip or may be coupled to the memory controllers 967 via an off-chip interface. In one implementation, the memory 966 comprises GDDR6 memory which shares the same virtual address space as other physical system-level memories, although the underlying principles described herein are not limited to this specific implementation.

The tensor cores 971 may include a plurality of execution units specifically designed to perform matrix operations, which are the fundamental compute operation used to perform deep learning operations. For example, simultaneous matrix multiplication operations may be used for neural network training and inferencing. The tensor cores 971 may perform matrix processing using a variety of operand precisions including single precision floating-point (e.g., 32 bits), half-precision floating point (e.g., 16 bits), integer words (16 bits), bytes (8 bits), and half-bytes (4 bits). For example, a neural network implementation extracts features of each rendered scene, potentially combining details from multiple frames, to construct a high-quality final image.

In deep learning implementations, parallel matrix multiplication work may be scheduled for execution on the tensor cores 971. The training of neural networks, in particular, requires a significant number of matrix dot product operations. In order to process an inner-product formulation of an N×N×N matrix multiply, the tensor cores 971 may include at least N dot-product processing elements. Before the matrix multiply begins, one entire matrix is loaded into tile registers and at least one column of a second matrix is loaded each cycle for N cycles. Each cycle, there are N dot products that are processed.

Matrix elements may be stored at different precisions depending on the particular implementation, including 16-bit words, 8-bit bytes (e.g., INT8) and 4-bit half-bytes (e.g., INT4). Different precision modes may be specified for the tensor cores 971 to ensure that the most efficient precision is used for different workloads (e.g., such as inferencing workloads which can tolerate quantization to bytes and half-bytes). Supported formats additionally include 64-bit floating point (FP64) and non-IEEE floating point formats such as the bfloat16 format (e.g., Brain floating point), a 16-bit floating point format with one sign bit, eight exponent bits, and eight significand bits, of which seven are explicitly stored. One example includes support for a reduced precision tensor-float (TF32) mode, which performs computations using the range of FP32 (8-bits) and the precision of FP16 (10-bits). Reduced precision TF32 operations can be performed on FP32 inputs and produce FP32 outputs at higher performance relative to FP32 and increased precision relative to FP16. In some examples, one or more 8-bit floating point formats (FP8) are supported.

In some examples the tensor cores 971 support a sparse mode of operation for matrices in which the vast majority of values are zero. The tensor cores 971 include support for sparse input matrices that are encoded in a sparse matrix representation (e.g., coordinate list encoding (COO), compressed sparse row (CSR), compress sparse column (CSC), etc.). The tensor cores 971 also include support for compressed sparse matrix representations in the event that the sparse matrix representation may be further compressed. Compressed, encoded, and/or compressed and encoded matrix data, along with associated compression and/or encoding metadata, can be read by the tensor cores 971 and the non-zero values can be extracted. For example, for a given input matrix A, a non-zero value can be loaded from the compressed and/or encoded representation of at least a portion of matrix A. Based on the location in matrix A for the non-zero value, which may be determined from index or coordinate metadata associated with the non-zero value, a corresponding value in input matrix B may be loaded. Depending on the operation to be performed (e.g., multiply), the load of the value from input matrix B may be bypassed if the corresponding value is a zero value. In some examples, the pairings of values for certain operations, such as multiply operations, may be pre-scanned by scheduler logic and only operations between non-zero inputs are scheduled. Depending on the dimensions of matrix A and matrix B and the operation to be performed, output matrix C may be dense or sparse. Where output matrix C is sparse and depending on the configuration of the tensor cores 971, output matrix C may be output in a compressed format, a sparse encoding, or a compressed sparse encoding.

The ray tracing cores 972 may accelerate ray tracing operations for both real-time ray tracing and non-real-time ray tracing implementations. In particular, the ray tracing cores 972 may include ray traversal/intersection circuitry for performing ray traversal using bounding volume hierarchies (BVHs) and identifying intersections between rays and primitives enclosed within the BVH volumes. The ray tracing cores 972 may also include circuitry for performing depth testing and culling (e.g., using a Z buffer or similar arrangement). In one implementation, the ray tracing cores 972 perform traversal and intersection operations in concert with the image denoising techniques described herein, at least a portion of which may be executed on the tensor cores 971. For example, the tensor cores 971 may implement a deep learning neural network to perform denoising of frames generated by the ray tracing cores 972. However, the CPU(s) 961, graphics cores 970, and/or ray tracing cores 972 may also implement all or a portion of the denoising and/or deep learning algorithms.

In addition, as described above, a distributed approach to denoising may be employed in which the GPU 980 is in a computing device coupled to other computing devices over a network or high-speed interconnect. In this distributed approach, the interconnected computing devices may share neural network learning/training data to improve the speed with which the overall system learns to perform denoising for different types of image frames and/or different graphics applications.

The ray tracing cores 972 may process all BVH traversal and/or ray-primitive intersections, saving the graphics cores 970 from being overloaded with thousands of instructions per ray. For example, each ray tracing core 972 includes a first set of specialized circuitry for performing bounding box tests (e.g., for traversal operations) and/or a second set of specialized circuitry for performing the ray-triangle intersection tests (e.g., intersecting rays which have been traversed). Thus, for example, the multi-core group 965A can simply launch a ray probe, and the ray tracing cores 972 independently perform ray traversal and intersection and return hit data (e.g., a hit, no hit, multiple hits, etc.) to the thread context. The other cores 970, 971 are freed to perform other graphics or compute work while the ray tracing cores 972 perform the traversal and intersection operations.

Optionally, each ray tracing core 972 may include a traversal unit to perform BVH testing operations and/or an intersection unit which performs ray-primitive intersection tests. The intersection unit generates a “hit”, “no hit”, or “multiple hit” response, which it provides to the appropriate thread. During the traversal and intersection operations, the execution resources of the other cores (e.g., graphics cores 970 and tensor cores 971) are freed to perform other forms of graphics work.

In some examples described below, a hybrid rasterization/ray tracing approach is used in which work is distributed between the graphics cores 970 and ray tracing cores 972.

The ray tracing cores 972 (and/or other cores 970, 971) may include hardware support for a ray tracing instruction set such as Microsoft's DirectX Ray Tracing (DXR) which includes a DispatchRays command, as well as ray-generation, closest-hit, any-hit, and miss shaders, which enable the assignment of unique sets of shaders and textures for each object. Another ray tracing platform which may be supported by the ray tracing cores 972, graphics cores 970 and tensor cores 971 is Vulkan API (e.g., Vulkan version 1.1.85 and later). Note, however, that the underlying principles described herein are not limited to any particular ray tracing ISA.

In general, the various cores 972, 971, 970 may support a ray tracing instruction set that includes instructions/functions for one or more of ray generation, closest hit, any hit, ray-primitive intersection, per-primitive and hierarchical bounding box construction, miss, visit, and exceptions. More specifically, some examples include ray tracing instructions to perform one or more of the following functions:
Ray Generation—Ray generation instructions may be executed for each pixel, sample, or other user-defined work assignment.
Closest Hit—A closest hit instruction may be executed to locate the closest intersection point of a ray with primitives within a scene.
Any Hit—An any hit instruction identifies multiple intersections between a ray and primitives within a scene, potentially to identify a new closest intersection point.
Intersection—An intersection instruction performs a ray-primitive intersection test and outputs a result.
Per-primitive Bounding box Construction—This instruction builds a bounding box around a given primitive or group of primitives (e.g., when building a new BVH or other acceleration data structure).
Miss—Indicates that a ray misses all geometry within a scene, or specified region of a scene.
Visit—Indicates the child volumes a ray will traverse.
Exceptions—Includes various types of exception handlers (e.g., invoked for various error conditions).

In some examples the ray tracing cores 972 may be adapted to accelerate general-purpose compute operations that can be accelerated using computational techniques that are analogous to ray intersection tests. A compute framework can be provided that enables shader programs to be compiled into low level instructions and/or primitives that perform general-purpose compute operations via the ray tracing cores. Exemplary computational problems that can benefit from compute operations performed on the ray tracing cores 972 include computations involving beam, wave, ray, or particle propagation within a coordinate space. Interactions associated with that propagation can be computed relative to a geometry or mesh within the coordinate space. For example, computations associated with electromagnetic signal propagation through an environment can be accelerated via the use of instructions or primitives that are executed via the ray tracing cores. Diffraction and reflection of the signals by objects in the environment can be computed as direct ray-tracing analogies.

Ray tracing cores 972 can also be used to perform computations that are not directly analogous to ray tracing. For example, mesh projection, mesh refinement, and volume sampling computations can be accelerated using the ray tracing cores 972. Generic coordinate space calculations, such as nearest neighbor calculations can also be performed. For example, the set of points near a given point can be discovered by defining a bounding box in the coordinate space around the point. BVH and ray probe logic within the ray tracing cores 972 can then be used to determine the set of point intersections within the bounding box. The intersections constitute the origin point and the nearest neighbors to that origin point. Computations that are performed using the ray tracing cores 972 can be performed in parallel with computations performed on the graphics cores 972 and tensor cores 971. A shader compiler can be configured to compile a compute shader or other general-purpose graphics processing program into low level primitives that can be parallelized across the graphics cores 970, tensor cores 971, and ray tracing cores 972.

Building larger and larger silicon dies is challenging for a variety of reasons. As silicon dies become larger, manufacturing yields become smaller and process technology requirements for different components may diverge. On the other hand, in order to have a high-performance system, key components should be interconnected by high speed, high bandwidth, low latency interfaces. These contradicting needs pose a challenge to high performance chip development.

Embodiments described herein provide techniques to disaggregate an architecture of a system on a chip integrated circuit into multiple distinct chiplets that can be packaged onto a common chassis. In some examples, a graphics processing unit or parallel processor is composed from diverse silicon chiplets that are separately manufactured. A chiplet is an at least partially packaged integrated circuit that includes distinct units of logic that can be assembled with other chiplets into a larger package. A diverse set of chiplets with different IP core logic can be assembled into a single device. Additionally the chiplets can be integrated into a base die or base chiplet using active interposer technology. The concepts described herein enable the interconnection and communication between the different forms of IP within the GPU. The development of IPs on different process may be mixed. This avoids the complexity of converging multiple IPs, especially on a large SoC with several flavors IPs, to the same process.

Enabling the use of multiple process technologies improves the time to market and provides a cost-effective way to create multiple product SKUs. For customers, this means getting products that are more tailored to their requirements in a cost effective and timely manner Additionally, the disaggregated IPs are more amenable to being power gated independently, components that are not in use on a given workload can be powered off, reducing overall power consumption.

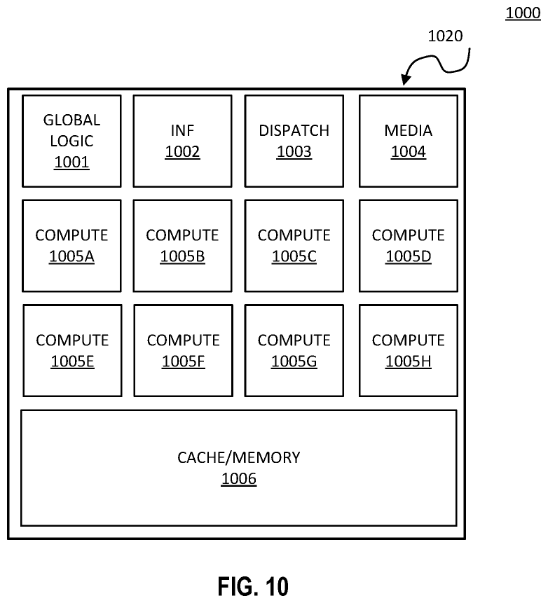

FIG. 10 shows a parallel compute system 1000, according to some examples. In some examples the parallel compute system 1000 includes a parallel processor 1020, which can be a graphics processor or compute accelerator as described herein. The parallel processor 1020 includes a global logic unit 1001, an interface 1002, a thread dispatcher 1003, a media unit 1004, a set of compute units 1005A-1005H, and a cache/memory units 1006. The global logic unit 1001, in some examples, includes global functionality for the parallel processor 1020, including device configuration registers, global schedulers, power management logic, and the like. The interface 1002 can include a front-end interface for the parallel processor 1020. The thread dispatcher 1003 can receive workloads from the interface 1002 and dispatch threads for the workload to the compute units 1005A-1005H. If the workload includes any media operations, at least a portion of those operations can be performed by the media unit 1004. The media unit can also offload some operations to the compute units 1005A-1005H. The cache/memory units 1006 can include cache memory (e.g., L3 cache) and local memory (e.g., HBM, GDDR) for the parallel processor 1020.

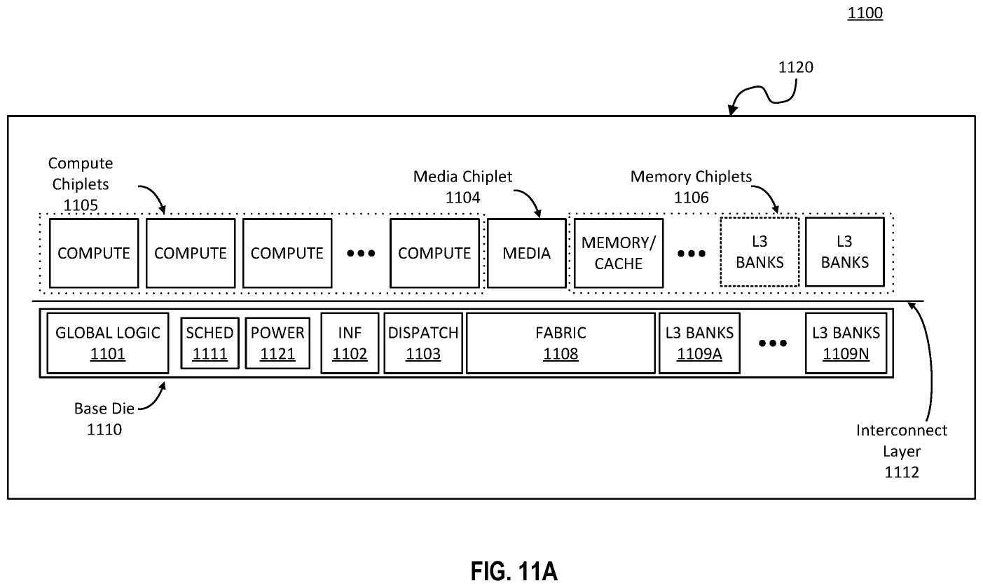

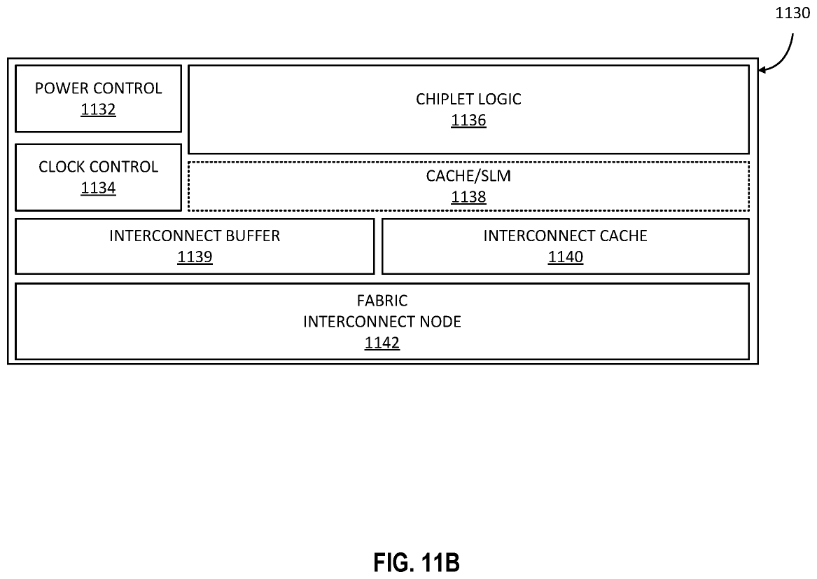

FIGS. 11A-11B illustrate a hybrid logical/physical view of a disaggregated parallel processor, according to examples described herein. FIG. 11A illustrates a disaggregated parallel compute system 1100. FIG. 11B illustrates a chiplet 1130 of the disaggregated parallel compute system 1100.

As shown in FIG. 11A, a disaggregated compute system 1100 can include a parallel processor 1120 in which the various components of the parallel processor SOC are distributed across multiple chiplets. Each chiplet can be a distinct IP core that is independently designed and configured to communicate with other chiplets via one or more common interfaces. The chiplets include but are not limited to compute chiplets 1105, a media chiplet 1104, and memory chiplets 1106. Each chiplet can be separately manufactured using different process technologies. For example, compute chiplets 1105 may be manufactured using the smallest or most advanced process technology available at the time of fabrication, while memory chiplets 1106 or other chiplets (e.g., I/O, networking, etc.) may be manufactured using a larger or less advanced process technologies.

The various chiplets can be bonded to a base die 1110 and configured to communicate with each other and logic within the base die 1110 via an interconnect layer 1112. In some examples, the base die 1110 can include global logic 1101, which can include scheduler 1111 and power management 1121 logic units, an interface 1102, a dispatch unit 1103, and an interconnect fabric module 1108 coupled with or integrated with one or more L3 cache banks 1109A-1109N. The interconnect fabric 1108 can be an inter-chiplet fabric that is integrated into the base die 1110. Logic chiplets can use the fabric 1108 to relay messages between the various chiplets. Additionally, L3 cache banks 1109A-1109N in the base die and/or L3 cache banks within the memory chiplets 1106 can cache data read from and transmitted to DRAM chiplets within the memory chiplets 1106 and to system memory of a host.

In some examples the global logic 1101 is a microcontroller that can execute firmware to perform scheduler 1111 and power management 1121 functionality for the parallel processor 1120. The microcontroller that executes the global logic can be tailored for the target use case of the parallel processor 1120. The scheduler 1111 can perform global scheduling operations for the parallel processor 1120. The power management 1121 functionality can be used to enable or disable individual chiplets within the parallel processor when those chiplets are not in use.

The various chiplets of the parallel processor 1120 can be designed to perform specific functionality that, in existing designs, would be integrated into a single die. A set of compute chiplets 1105 can include clusters of compute units (e.g., execution units, streaming multiprocessors, etc.) that include programmable logic to execute compute or graphics shader instructions. A media chiplet 1104 can include hardware logic to accelerate media encode and decode operations. Memory chiplets 1106 can include volatile memory (e.g., DRAM) and one or more SRAM cache memory banks (e.g., L3 banks).

As shown in FIG. 11B, each chiplet 1130 can include common components and application specific components. Chiplet logic 1136 within the chiplet 1130 can include the specific components of the chiplet, such as an array of streaming multiprocessors, compute units, or execution units described herein. The chiplet logic 1136 can couple with an optional cache or shared local memory 1138 or can include a cache or shared local memory within the chiplet logic 1136. The chiplet 1130 can include a fabric interconnect node 1142 that receives commands via the inter-chiplet fabric. Commands and data received via the fabric interconnect node 1142 can be stored temporarily within an interconnect buffer 1139. Data transmitted to and received from the fabric interconnect node 1142 can be stored in an interconnect cache 1140. Power control 1132 and clock control 1134 logic can also be included within the chiplet. The power control 1132 and clock control 1134 logic can receive configuration commands via the fabric can configure dynamic voltage and frequency scaling for the chiplet 1130. In some examples, each chiplet can have an independent clock domain and power domain and can be clock gated and power gated independently of other chiplets.

At least a portion of the components within the illustrated chiplet 1130 can also be included within logic embedded within the base die 1110 of FIG. 11A. For example, logic within the base die that communicates with the fabric can include a version of the fabric interconnect node 1142. Base die logic that can be independently clock or power gated can include a version of the power control 1132 and/or clock control 1134 logic.

Thus, while various examples described herein use the term SOC to describe a device or system having a processor and associated circuitry (e.g., Input/Output (“I/O”) circuitry, power delivery circuitry, memory circuitry, etc.) integrated monolithically into a single Integrated Circuit (“IC”) die, or chip, the present disclosure is not limited in that respect. For example, in various examples of the present disclosure, a device or system can have one or more processors (e.g., one or more processor cores) and associated circuitry (e.g., Input/Output (“I/O”) circuitry, power delivery circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems the various dies, tiles and/or chiplets can be physically and electrically coupled together by a package structure including, for example, various packaging substrates, interposers, active interposers, photonic interposers, interconnect bridges and the like. The disaggregated collection of discrete dies, tiles, and/or chiplets can also be part of a System-on-Package (“SoP”).”

Graphics Pipeline

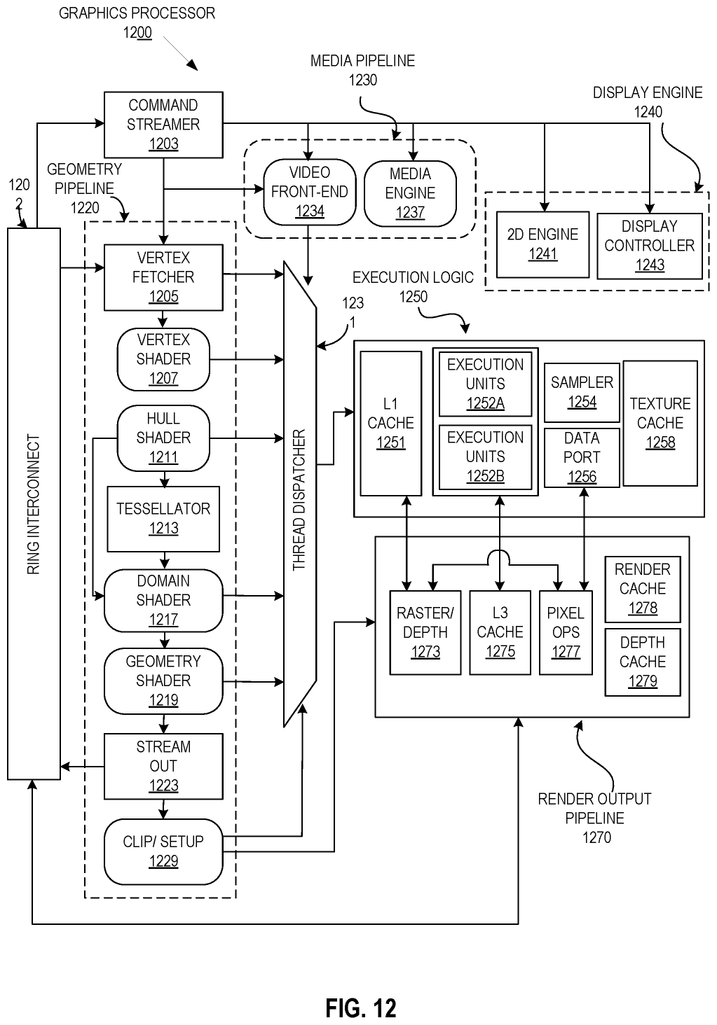

FIG. 12 is a block diagram of another example of a graphics processor 1200. Elements of FIG. 12 having the same reference numbers (or names) as the elements of any other figure herein can operate or function in any manner similar to that described elsewhere herein, but are not limited to such.

In some examples, graphics processor 1200 includes a geometry pipeline 1220, a media pipeline 1230, a display engine 1240, thread execution logic 1250, and a render output pipeline 1270. In some examples, graphics processor 1200 is a graphics processor within a multi-core processing system that includes one or more general-purpose processing cores. The graphics processor is controlled by register writes to one or more control registers (not shown) or via commands issued to graphics processor 1200 via a ring interconnect 1202. In some examples, ring interconnect 1202 couples graphics processor 1200 to other processing components, such as other graphics processors or general-purpose processors. Commands from ring interconnect 1202 are interpreted by a command streamer 1203, which supplies instructions to individual components of the geometry pipeline 1220 or the media pipeline 1230.

In some examples, command streamer 1203 directs the operation of a vertex fetcher 1205 that reads vertex data from memory and executes vertex-processing commands provided by command streamer 1203. In some examples, vertex fetcher 1205 provides vertex data to a vertex shader 1207, which performs coordinate space transformation and lighting operations to each vertex. In some examples, vertex fetcher 1205 and vertex shader 1207 execute vertex-processing instructions by dispatching execution threads to execution units 1252A-1252B via a thread dispatcher 1231.

In some examples, execution units 1252A-1252B are an array of vector processors having an instruction set for performing graphics and media operations. In some examples, execution units 1252A-1252B have an attached L1 cache 1251 that is specific for each array or shared between the arrays. The cache can be configured as a data cache, an instruction cache, or a single cache that is partitioned to contain data and instructions in different partitions.

In some examples, geometry pipeline 1220 includes tessellation components to perform hardware-accelerated tessellation of 3D objects. In some examples, a programmable hull shader 1211 configures the tessellation operations. A programmable domain shader 1217 provides back-end evaluation of tessellation output. A tessellator 1213 operates at the direction of hull shader 1211 and contains special purpose logic to generate a set of detailed geometric objects based on a coarse geometric model that is provided as input to geometry pipeline 1220. In some examples, if tessellation is not used, tessellation components (e.g., hull shader 1211, tessellator 1213, and domain shader 1217) can be bypassed.

In some examples, complete geometric objects can be processed by a geometry shader 1219 via one or more threads dispatched to execution units 1252A-1252B, or can proceed directly to the clipper 1229. In some examples, the geometry shader operates on entire geometric objects, rather than vertices or patches of vertices as in previous stages of the graphics pipeline. If the tessellation is disabled, the geometry shader 1219 receives input from the vertex shader 1207. In some examples, geometry shader 1219 is programmable by a geometry shader program to perform geometry tessellation if the tessellation units are disabled.

Before rasterization, a clipper 1229 processes vertex data. The clipper 1229 may be a fixed function clipper or a programmable clipper having clipping and geometry shader functions. In some examples, a rasterizer and depth test component 1273 in the render output pipeline 1270 dispatches pixel shaders to convert the geometric objects into per pixel representations. In some examples, pixel shader logic is included in thread execution logic 1250. In some examples, an application can bypass the rasterizer and depth test component 1273 and access un-rasterized vertex data via a stream out unit 1223.

The graphics processor 1200 has an interconnect bus, interconnect fabric, or some other interconnect mechanism that allows data and message passing amongst the major components of the processor. In some examples, execution units 1252A-1252B and associated logic units (e.g., L1 cache 1251, sampler 1254, texture cache 1258, etc.) interconnect via a data port 1256 to perform memory access and communicate with render output pipeline components of the processor. In some examples, sampler 1254, caches 1251, 1258 and execution units 1252A-1252B each have separate memory access paths. In some examples the texture cache 1258 can also be configured as a sampler cache.

In some examples, render output pipeline 1270 contains a rasterizer and depth test component 1273 that converts vertex-based objects into an associated pixel-based representation. In some examples, the rasterizer logic includes a windower/masker unit to perform fixed function triangle and line rasterization. An associated render cache 1278 and depth cache 1279 are also available in some examples. A pixel operations component 1277 performs pixel-based operations on the data, though in some instances, pixel operations associated with 2D operations (e.g., bit block image transfers with blending) are performed by the 2D engine 1241, or substituted at display time by the display controller 1243 using overlay display planes. In some examples, a shared L3 cache 1275 is available to all graphics components, allowing the sharing of data without the use of main system memory.

In some examples, graphics processor media pipeline 1230 includes a media engine 1237 and a video front-end 1234. In some examples, video front-end 1234 receives pipeline commands from the command streamer 1203. In some examples, media pipeline 1230 includes a separate command streamer. In some examples, video front-end 1234 processes media commands before sending the command to the media engine 1237. In some examples, media engine 1237 includes thread spawning functionality to spawn threads for dispatch to thread execution logic 1250 via thread dispatcher 1231.

In some examples, graphics processor 1200 includes a display engine 1240. In some examples, display engine 1240 is external to processor 1200 and couples with the graphics processor via the ring interconnect 1202, or some other interconnect bus or fabric. In some examples, display engine 1240 includes a 2D engine 1241 and a display controller 1243. In some examples, display engine 1240 contains special purpose logic capable of operating independently of the 3D pipeline. In some examples, display controller 1243 couples with a display device (not shown), which may be a system integrated display device, as in a laptop computer, or an external display device attached via a display device connector.

In some examples, the geometry pipeline 1220 and media pipeline 1230 are configurable to perform operations based on multiple graphics and media programming interfaces and are not specific to any one application programming interface (API). In some examples, driver software for the graphics processor translates API calls that are specific to a particular graphics or media library into commands that can be processed by the graphics processor. In some examples, support is provided for the Open Graphics Library (OpenGL), Open Computing Language (OpenCL), and/or Vulkan graphics and compute API, all from the Khronos Group. In some examples, support may also be provided for the Direct3D library from the Microsoft Corporation. In some examples, a combination of these libraries may be supported. Support may also be provided for the Open Source Computer Vision Library (OpenCV). A future API with a compatible 3D pipeline would also be supported if a mapping can be made from the pipeline of the future API to the pipeline of the graphics processor.

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

Emulation (Including Binary Translation, Code Morphing, Etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

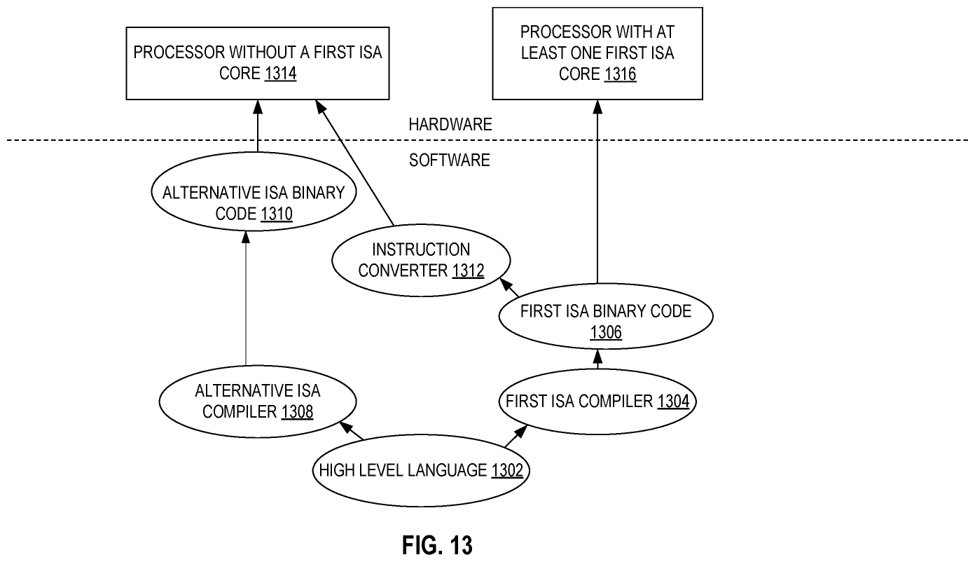

FIG. 13 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 13 shows a program in a high-level language 1302 may be compiled using a first ISA compiler 1304 to generate first ISA binary code 1306 that may be natively executed by a processor with at least one first ISA core 1316. The processor with at least one first ISA core 1316 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 1304 represents a compiler that is operable to generate first ISA binary code 1306 (e.g., object code) that can, with or without additional linkage processing, be executed on the processor with at least one first ISA core 1316. Similarly, FIG. 13 shows the program in the high-level language 1302 may be compiled using an alternative ISA compiler 1308 to generate alternative ISA binary code 1310 that may be natively executed by a processor without a first ISA core 1314. The instruction converter 1312 is used to convert the first ISA binary code 1306 into code that may be natively executed by the processor without a first ISA core 1314. This converted code is not necessarily to be the same as the alternative ISA binary code 1310; however, the converted code will accomplish the general operation and be made up of instructions from the alternative ISA. Thus, the instruction converter 1312 represents software, firmware, hardware, or a combination thereof that, through emulation, simulation or any other process, allows a processor or other electronic device that does not have a first ISA processor or core to execute the first ISA binary code 1306.

IP Core Implementations

One or more aspects of at least some examples may be implemented by representative code stored on a machine-readable medium which represents and/or defines logic within an integrated circuit such as a processor. For example, the machine-readable medium may include instructions which represent various logic within the processor. When read by a machine, the instructions may cause the machine to fabricate the logic to perform the techniques described herein. Such representations, known as “IP cores,” are reusable units of logic for an integrated circuit that may be stored on a tangible, machine-readable medium as a hardware model that describes the structure of the integrated circuit. The hardware model may be supplied to various customers or manufacturing facilities, which load the hardware model on fabrication machines that manufacture the integrated circuit. The integrated circuit may be fabricated such that the circuit performs operations described in association with any of the examples described herein.

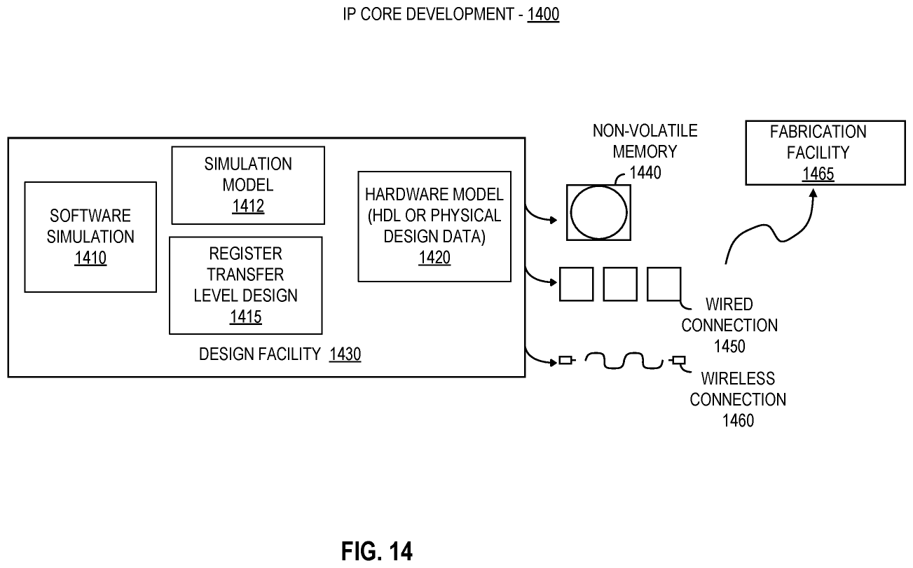

FIG. 14 is a block diagram illustrating an IP core development system 1400 that may be used to manufacture an integrated circuit to perform operations according to some examples. The IP core development system 1400 may be used to generate modular, re-usable designs that can be incorporated into a larger design or used to construct an entire integrated circuit (e.g., an SOC integrated circuit). A design facility 1430 can generate a software simulation 1410 of an IP core design in a high-level programming language (e.g., C/C++). The software simulation 1410 can be used to design, test, and verify the behavior of the IP core using a simulation model 1412. The simulation model 1412 may include functional, behavioral, and/or timing simulations. A register transfer level (RTL) design 1415 can then be created or synthesized from the simulation model 1412. The RTL design 1415 is an abstraction of the behavior of the integrated circuit that models the flow of digital signals between hardware registers, including the associated logic performed using the modeled digital signals. In addition to an RTL design 1415, lower-level designs at the logic level or transistor level may also be created, designed, or synthesized. Thus, the particular details of the initial design and simulation may vary.

The RTL design 1415 or equivalent may be further synthesized by the design facility into a hardware model 1420, which may be in a hardware description language (HDL), or some other representation of physical design data. The HDL may be further simulated or tested to verify the IP core design. The IP core design can be stored for delivery to a 3^{rd} party fabrication facility 1465 using non-volatile memory 1440 (e.g., hard disk, flash memory, or any non-volatile storage medium). Alternatively, the IP core design may be transmitted (e.g., via the Internet) over a wired connection 1450 or wireless connection 1460. The fabrication facility 1465 may then fabricate an integrated circuit that is based at least in part on the IP core design. The fabricated integrated circuit can be configured to perform operations in accordance with at least some examples described herein.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

An embodiment is an implementation or example of the disclosure. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the disclosure. The various appearances “an embodiment,” “one embodiment,” or “some embodiments” are not necessarily all referring to the same embodiments.

Not all components, features, structures, characteristics, etc. described and illustrated herein need to be included in a particular embodiment or embodiments. If the specification states a component, feature, structure, or characteristic “may”, “might”, “can”, or “could” be included, for example, that particular component, feature, structure, or characteristic is not required to be included. If the specification or claim refers to “a” or “an” element, that does not mean there is only one of the elements. If the specification or claims refer to “an additional” element, that does not preclude there being more than one of the additional elements.

The above description of illustrated embodiments of the disclosure, including what is described in the Abstract, is not intended to be exhaustive or to limit the disclosure to the precise forms disclosed. While specific embodiments of, and examples for, the disclosure are described herein for illustrative purposes, various equivalent modifications are possible within the scope of the disclosure, as those skilled in the relevant art will recognize.

These modifications can be made to the disclosure in light of the above detailed description. The terms used in the following claims should not be construed to limit the disclosure to the specific embodiments disclosed in the specification and the drawings. Rather, the scope of the disclosure is to be determined entirely by the following claims, which are to be construed in accordance with established doctrines of claim interpretation.

### Further Examples

Example 1 provides an exemplary method comprising: distributing messages to a set of processor cores of a processor, wherein one message is distributed per distribution round to one queue within a set of queues, each queue corresponding to one processor core within the set of processor cores and including one or more queue entries to be processed by the one processor core, and wherein the distribution is based on utilization of the set of queues; based on utilization of a corresponding queue for a processor core of the set of processor cores, determining a power state for the processor core to be changed to; and distributing a message to the corresponding queue, the message to cause the processor core to be set to the power state.

Example 2 includes the substance of Example 1, wherein the power state for the processor core is an updated performance state for the processor core, and the updated performance state is determined based on a mapping of the updated performance state and the utilization of the corresponding queue.

Example 3 includes the substance of Examples 1 to 2, wherein a data structure stores mappings between a plurality of performance states and a corresponding plurality of utilization levels, and determining the updated performance state for the processor core is based on looking up of the data structure.

Example 4 includes the substance of Examples 1 to 3, wherein the processor core was brought to an active state from an idle state through a monitor instruction to the processor core before messages were distributed to the processor core.

Example 5 includes the substance of Examples 1 to 4, wherein the processor core was brought to the active state through a message indicating the monitor instruction, wherein the monitor instruction is triggered by a call from another core of the processor.

Example 6 includes the substance of Examples 1 to 5, wherein the utilization of the corresponding queue is measured by a plurality of utilization levels, and wherein responsive to a utilization level is no higher than a first threshold, the processor core is to be set to an idle state.

Example 7 includes the substance of Examples 1 to 6, wherein the utilization of the corresponding queue is measured by a plurality of utilization levels, wherein responsive to the utilization level crosses a second threshold, the processor core is to be set to a turbo mode, in which the processor core is to run at a frequency higher than an advertised frequency of the processor core.

Example 8 includes the substance of Examples 1 to 7, wherein the power state for the processor core is an idle state and the message indicates a wait instruction, based on which the processor core enters the idle state until an event occurs.

Example 9 includes the substance of Examples 1 to 8, wherein the idle state is selected from a plurality of idle states based on the wait instruction.

Example 10 includes the substance of Examples 1 to 9, wherein the processor core is set to the power state using a Data Plane Development Kit (DPDK) application coupled to the processor core.

Example 11 provides an exemplary system comprising: a set of processor cores of a processor; and circuitry to distribute messages to the set of processor cores of the processor, wherein one message is distributed per distribution round to one queue within a set of queues, each queue to correspond to one processor core within the set of processor cores and include one or more queue entries to be processed by the one processor core, and wherein the distribution is based on utilization of the set of queues, the circuitry to: based on utilization of a corresponding queue for a processor core of the set of processor cores, determine a power state for the processor core to be changed to, and distribute a message to the corresponding queue, the message to cause the processor core to be set to the power state.

Example 12 includes the substance of Example 11, wherein the power state for the processor core is an updated performance state for the processor core, and the updated performance state is determined based on a mapping of the updated performance state and the utilization of the corresponding queue.

Example 13 includes the substance of Examples 11 to 12, wherein the processor core was brought to an active state from an idle state through a monitor instruction to the processor core before messages were distributed to the processor core.

Example 14 includes the substance of Examples 11 to 13, wherein the utilization of the corresponding queue is measured by a plurality of utilization levels, and wherein responsive to a utilization level is no higher than a first threshold, the processor core is to be set to an idle state.

Example 15 includes the substance of Examples 11 to 14, wherein the power state for the processor core is an idle state and the message indicates a wait instruction, based on which the processor core enters the idle state until an event occurs.

Example 16 provides an exemplary computer-readable storage medium storing instructions that when executed by a processor, are capable of causing the processor to perform: distributing messages to a set of processor cores of a processor, wherein one message is distributed per distribution round to one queue within a set of queues, each queue corresponding to one processor core within the set of processor cores and including one or more queue entries to be processed by the one processor core, and wherein the distribution is based on utilization of the set of queues; based on utilization of a corresponding queue for a processor core of the set of processor cores, determining a power state for the processor core to be changed to; and distributing a message to the corresponding queue, the message to cause the processor core to be set to the power state.

Example 17 includes the substance of Example 16, wherein the power state for the processor core is an updated performance state for the processor core, and the updated performance state is determined based on a mapping of the updated performance state and the utilization of the corresponding queue.

Example 18 includes the substance of Examples 16 to 17, wherein a data structure stores mappings between a plurality of performance states and a corresponding plurality of utilization levels, and determining the updated performance state for the processor core is based on looking up of the data structure.

Example 19 includes the substance of Examples 16 to 18, wherein the utilization of the corresponding queue is measured by a plurality of utilization levels, wherein responsive to the utilization level crosses a second threshold, the processor core is to be set to a turbo mode, in which the processor core is to run at a frequency higher than an advertised frequency of the processor core.

Example 20 includes the substance of Examples 16 to 19, wherein the processor core is set to the power state using a Data Plane Development Kit (DPDK) application coupled to the processor core.

### ADDITIONAL EXPLANATION

Embodiments of the disclosure may include various steps, which have been described above. The steps may be embodied in machine-executable instructions which may be used to cause a general-purpose or special-purpose processor to perform the steps. Alternatively, these steps may be performed by specific hardware components that contain hardwired logic for performing the steps, or by any combination of programmed computer components and custom hardware components.

As described herein, instructions may refer to specific configurations of hardware such as application specific integrated circuits (ASICs) configured to perform certain operations or having a predetermined functionality or software instructions stored in memory embodied in a non-transitory computer-readable medium. Thus, the techniques shown in the Figures can be implemented using code and data stored and executed on one or more electronic devices (e.g., an end station, a network element, etc.). Such electronic devices store and communicate (internally and/or with other electronic devices over a network) code and data using computer machine-readable media, such as non-transitory computer machine-readable storage media (e.g., magnetic disks; optical disks; random access memory; read only memory; flash memory devices; phase-change memory) and transitory computer machine-readable communication media (e.g., electrical, optical, acoustical, or other form of propagated signals—such as carrier waves, infrared signals, digital signals, etc.). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more buses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device. Of course, one or more parts of an embodiment of the disclosure may be implemented using different combinations of software, firmware, and/or hardware. Throughout this detailed description, for the purposes of explanation, numerous specific details were set forth in order to provide a thorough understanding of the present disclosure. It will be apparent, however, to one skilled in the art that the disclosure may be practiced without some of these specific details. In certain instances, well-known structures and functions were not described in elaborate detail in order to avoid obscuring the subject matter of the present disclosure. Accordingly, the scope and spirit of the disclosure should be judged in terms of the claims which follow.

What is claimed is:

1. A method comprising:
distributing messages to a set of processor cores of a processor, wherein one message is distributed per distribution round to one queue within a set of queues, each queue corresponding to one processor core within the set of processor cores and including one or more queue entries to be processed by the one processor core, and wherein the distribution is based on utilization of the set of queues;
based on utilization of a corresponding queue for a processor core of the set of processor cores, determining a power state for the processor core to be changed to; and
distributing a message to the corresponding queue, the message to cause the processor core to be set to the power state.

2. The method of claim 1, wherein the power state for the processor core is an updated performance state for the processor core, and the updated performance state is determined based on a mapping of the updated performance state and the utilization of the corresponding queue.

3. The method of claim 2, wherein a data structure stores mappings between a plurality of performance states and a corresponding plurality of utilization levels, and determining the updated performance state for the processor core is based on looking up of the data structure.

4. The method of claim 1, wherein the processor core was brought to an active state from an idle state through a monitor instruction to the processor core before messages were distributed to the processor core.

5. The method of claim 4, wherein the processor core was brought to the active state through a message indicating the monitor instruction, wherein the monitor instruction is triggered by a call from another core of the processor.

6. The method of claim 1, wherein the utilization of the corresponding queue is measured by a plurality of utilization levels, and wherein responsive to a utilization level is no higher than a first threshold, the processor core is to be set to an idle state.

7. The method of claim 1, wherein the utilization of the corresponding queue is measured by a plurality of utilization levels, wherein responsive to the utilization level crosses a second threshold, the processor core is to be set to a turbo mode, in which the processor core is to run at a frequency higher than an advertised frequency of the processor core.

8. The method of claim 1, wherein the power state for the processor core is an idle state and the message indicates a wait instruction, based on which the processor core enters the idle state until an event occurs.

9. The method of claim 8, wherein the idle state is selected from a plurality of idle states based on the wait instruction.

10. The method of claim 1, wherein the processor core is set to the power state using a Data Plane Development Kit (DPDK) application coupled to the processor core.

11. A system comprising:
a set of processor cores of a processor; and
circuitry to distribute messages to the set of processor cores of the processor, wherein one message is distributed per distribution round to one queue within a set of queues, each queue to correspond to one processor core within the set of processor cores and include one or more queue entries to be processed by the one processor core, and wherein the distribution is based on utilization of the set of queues, the circuitry to:
based on utilization of a corresponding queue for a processor core of the set of processor cores, determine a power state for the processor core to be changed to, and
distribute a message to the corresponding queue, the message to cause the processor core to be set to the power state.

12. The system of claim 11, wherein the power state for the processor core is an updated performance state for the processor core, and the updated performance state is determined based on a mapping of the updated performance state and the utilization of the corresponding queue.

13. The system of claim 11, wherein the processor core was brought to an active state from an idle state through a monitor instruction to the processor core before messages were distributed to the processor core.

14. The system of claim 11, wherein the utilization of the corresponding queue is measured by a plurality of utilization levels, and wherein responsive to a utilization level is no higher than a first threshold, the processor core is to be set to an idle state.

15. The system of claim 11, wherein the power state for the processor core is an idle state and the message indicates a wait instruction, based on which the processor core enters the idle state until an event occurs.

16. A non-transitory computer-readable storage medium storing instructions that when executed by a processor, are capable of causing the processor to perform:
distributing messages to a set of processor cores of a processor, wherein one message is distributed per distribution round to one queue within a set of queues, each queue corresponding to one processor core within the set of processor cores and including one or more queue entries to be processed by the one processor core, and wherein the distribution is based on utilization of the set of queues;
based on utilization of a corresponding queue for a processor core of the set of processor cores, determining a power state for the processor core to be changed to; and
distributing a message to the corresponding queue, the message to cause the processor core to be set to the power state.

17. The non-transitory computer-readable storage medium of claim 16, wherein the power state for the processor core is an updated performance state for the processor core, and the updated performance state is determined based on a mapping of the updated performance state and the utilization of the corresponding queue.

18. The non-transitory computer-readable storage medium of claim 17, wherein a data structure stores mappings between a plurality of performance states and a corresponding plurality of utilization levels, and determining the updated performance state for the processor core is based on looking up of the data structure.

19. The non-transitory computer-readable storage medium of claim 16, wherein the utilization of the corresponding queue is measured by a plurality of utilization levels, wherein responsive to the utilization level crosses a second threshold, the processor core is to be set to a turbo mode, in which the processor core is to run at a frequency higher than an advertised frequency of the processor core.

20. The non-transitory computer-readable storage medium of claim 16, wherein the processor core is set to the power state using a Data Plane Development Kit (DPDK) application coupled to the processor core.
